(19) United States
(12) Patent Application Publication
(10) Pub. No.: US 2023/0295401 A1
(43) Pub. Date: Sep. 21, 2023

(54) REINFORCEMENT AND FILLER MATERIALS AND COMPOSITES THEREOF

(71) Applicant: UNIVERSITY OF WYOMING, Laramie, WY (US)

(72) Inventors: Robert H. BRADLEY, Laramie, WY (US); Richard HORNER, Laramie, WY (US)

(21) Appl. No.: 18/122,825

(22) Filed: Mar. 17, 2023

Related U.S. Application Data
(60) Provisional application No. 63/321,565, filed on Mar. 18, 2022.

(51) Int. Cl. C08K 11/00; C08L 23/06; C08L 23/12; B29C 48/00; C08L 53/02; C08J 3/24; C08J 3/22

(52) U.S. Cl. CPC C08K 11/005; C08L 23/06; C08L 23/12; B29C 48/022; C08L 53/02; C08J 3/24; C08J 3/22; C08K 2201/006; B29K 2509/00

(57) ABSTRACT

Embodiments of the present disclosure generally relate to reinforcement and filler materials in various compositions, and more specifically to coal-derived materials as reinforcement and filler materials. In an embodiment, a composition includes a coal-derived component and an elastomer component. The coal-derived component can be coal powder and/or coal char. The coal-derived component can be thermally-treated (e.g., pyrolyzed), solvent-extracted to produce an extract or residual carbon, and/or chemically modified prior to incorporation in the composition.

### CROSS-REFERENCE TO RELATED APPLICATIONS

This application claims priority to U.S. Provisional Application No. 63/321,565, filed Mar. 18, 2022, the entirety of which is herein incorporated by reference.

### BACKGROUND

### Field

Embodiments of the present disclosure generally relate to coal derived carbon reinforcement and filler materials of various compositions, varying properties and in various forms for uses that include composite material products and applications.

### Description of the Related Art

Rubber and plastic (thermoplastics and thermosets) compositions (termed composite materials) are utilized in a variety of applications such as automotive, energy, chemical industry, electrical cabling, construction, packaging, agricultural, and healthcare industries. For example, rubber compositions are included in tires, seals, household and sporting goods, while plastic compositions are included in fluid transport pipes, packaging, and engineered products that offer high strength and lightweight characteristics together with corrosion resistance. Such rubber and plastic compositions, in composite material form typically include carbon black, carbon-based fibers, carbon-based fibrils, graphitic platelets, carbon-based whiskers, and spherical porous carbon morphologies. Such compositions are used as a strengthening aid, reinforcement, to convey electrical properties, improve physical performance, or act as a diluent filler, when added to plastic or rubber base materials to form composite materials. However, such additive carbon materials can represent a large expenditure in composition manufacturing. For example, carbon black retails up to about $25 per kilogram depending on the grade.

There is a need for cheaper and improved performance carbon reinforcement and filler materials, that can be manufactured in ways that improve environmental impact, including pollution reduction and climate change contribution, either by using different feedstocks or syntheses or processing the carbon compositions in more responsible and effective ways, for uses in composite materials and applications.

### SUMMARY

Embodiments of the present disclosure generally relate to reinforcement and filler materials in various compositions, and more specifically to coal-derived materials as reinforcement and filler materials.

In an embodiment, a composition is provided. The composition includes a coal-derived component comprising coal powder, coal char produced by thermal treatment such as pyrolysis, or solvent extraction to produce an extract or residual carbon or a combination thereof, and an elastomer component.

In another embodiment, a composition is provided. The composition includes a coal-derived component comprising coal powder, coal char, or a combination thereof, and a thermoplastic component, wherein the composition includes from about 20 wt % to about 60 wt % of the coal-derived component based on a total weight of the composition, from about 40 wt % to about 80 wt % of the thermoplastic component based on the total weight of the composition, and wherein the total weight percent of the composition does not exceed 100 wt %.

In another embodiment, a method of producing a composition is provided. The method includes vulcanizing a mixture comprising a coal-derived component, an elastomer component, and a curative to produce the composition

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is an example representation of filler colloidal properties.

FIG. 2 is an example representation of filler colloidal properties of standard furnace grades of carbon black.

FIG. 3 shows toluene discoloration transmittance values of standard furnace grades of carbon black according to at least one embodiment of the present disclosure.

FIG. 4 shows exemplary thermogravimetric analysis (TGA) data for an example coal powder according to at least one embodiment of the present disclosure.

FIG. 5A is an exemplary scanning electron microscopy (SEM) image of the ash remaining after the TGA analysis of FIG. 4 according to at least one embodiment of the present disclosure.

FIG. 5B shows exemplary energy dispersive X-ray (EDX) analysis data of the ash remaining after the TGA analysis of FIG. 4 according to at least one embodiment of the present disclosure.

FIG. 6 is an exemplary infrared (IR) spectrum for an example coal powder after solvent extraction according to at least one embodiment of the present disclosure.

FIG. 7 shows exemplary data for gas chromatography-mass spectroscopy of an example coal powder after solvent extraction according to at least one embodiment of the present disclosure.

FIG. 8A shows an exemplary strain sweep plot of an example composition containing coal powder and a comparative composition containing carbon black according to at least one embodiment of the present disclosure.

FIG. 8B shows an exemplary strain sweep plot of an example composition containing coal powder and a comparative composition containing carbon black according to at least one embodiment of the present disclosure.

FIG. 9A is an exemplary optical image of an example composition containing coal char according to at least one embodiment of the present disclosure.

FIG. 9B is an example three dimensional scanning electron microscopy (3D SEM) surface roughness map of an example composition containing coal char according to at least one embodiment of the present disclosure.

FIG. 9C is an optical image of a comparative composition containing carbon black (grade N772).

FIG. 9D is a 3D SEM surface roughness map of a comparative composition containing carbon black (grade N772).

FIG. 9E is an optical image of a comparative composition containing carbon black (grade N326).

FIG. 9F is a 3D SEM surface roughness map of a comparative composition containing carbon black (grade N326).

FIG. 10A shows an exemplary strain sweep plot of an example composition containing coal char and a comparative composition containing carbon black according to at least one embodiment of the present disclosure.

FIG. 10B shows an exemplary strain sweep plot of an example composition containing coal char and a comparative composition containing carbon black according to at least one embodiment of the present disclosure.

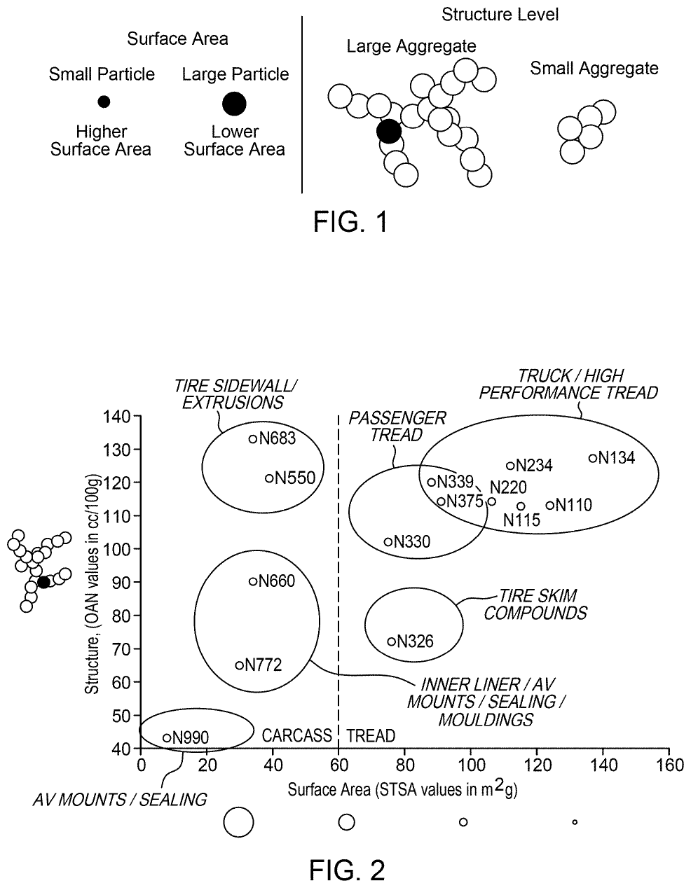

To facilitate understanding, identical reference numerals have been used, where possible, to correspond with matching elements that are common to the figures. It is contemplated that elements and features of one embodiment may be beneficially incorporated in other embodiments without further recitation.

### DETAILED DESCRIPTION

Embodiments of the present disclosure generally relate to carbon derived from coal reinforcement and filler materials in various compositions, and more specifically to such materials used as reinforcement and filler materials. The compositions include coal-derived carbon materials as reinforcement and filler materials having structural properties. Briefly, the compositions include a coal-derived component and one or more of a rubber (e.g., elastomer), thermoplastic, and/or thermosetting resin such as epoxy. The compositions can further include other carbon additives or a combination of additives with carbon-based filler and reinforcing materials depending on the application.

As described herein, coal-derived materials, such as coal powders (CP) and coal chars, have been synthesized and utilized as a reinforcement and/or a filler material (e.g., diluent filler) in rubber compositions, elastomer compositions, polymer compositions such as thermoplastics and thermosetting resins such as epoxies, and other coal derived matrix materials. These and other compositions described herein represent a new family of compositions which have been derived from coal, exhibiting new and commercially attractive properties. The compositions of these coal-derived materials can be useful in a wide variety of products and their applications such as automotive, energy, construction, electrical, chemicals, packaging, agricultural, and healthcare industries, among others. For example, the compositions described herein based upon a rubber matrix can be used for tires, serpentine and timing belts, power belts, window sealants, construction materials (e.g., blocks, load-bearing structures, and roofing spans), membranes, sealant compounds, personal protective equipment such as facemasks and garment liners, fluid and gas transport pipes, hoses and liners for electrical wires, hoses and liners for dairy equipment such as milking machines and other agricultural equipment, seal and O-ring products, innertubes, mechanical goods, hoses, and electrical products, among other products. Similarly compositions based upon a plastic matrix can be used in engineering applications, requiring high strength, lightweight and corrosion resistance properties.

The coal-derived materials can replace reinforcing-grade carbon blacks, and/or carbon-based fibers, fibril and whiskers in composite structures that are derived from alternative high carbon content feedstocks such as oil and natural gas. Moreover, the coal-derived materials can be used as a bulk filler, blend filler, and/or diluent filler for compositions and possess advantages such as can be produced using sustainable practices to minimize pollution and environmental impacts.

As a non-limiting example, coal char can be used as a reinforcing filler. Specifically, and in some examples, rubber compositions that include coal char indicate performance levels—e.g., hardness modulus, and tensile strength—comparable to commercially available carbon blacks made from other high carbon content feedstocks such as natural gas and oil, such as N990, N772, N330, etc.

Embodiments described herein utilize two distinct carbons—a coal powder and a coal char. These materials can be characterized as having relatively low surface areas. Both the coal powder and the coal char can be milled to provide micron-sized powders which can aid dispersion when mixed with matrix compounds. Both the coal powder and the coal char can be surface treated with chemicals to, e.g., enhance interactions with the matrix such as bonding with the matrix and distribution through the matrix. Additionally, the surface treatment may be tailored to give specific surface groups which further improves composites including the coal powder or coal char.

Conventionally, activated carbon has been utilized for reinforcing rubber. In contrast to the carbon materials described herein, activated carbon is highly porous, high surface area materials having a distinctly different microstructure than coal powder and coal chars described herein.

In some examples, the carbon materials described herein can be engineered for specific applications by changing PSD and surface chemistry, in turn controlling dispersion in, and bonding with, individual matrix materials. For example, the relative amount of polar and non-polar interactivity can be controlled via, e.g., surface treatments.

### Formulations of the Compositions

Compositions described herein include a coal-derived component with a matrix component, such as rubber or plastic. The coal-derived component can come from any suitable source such as the Powder River Basin (PRB). The coal-derived component can be, e.g., a coal powder and/or a coal char and/or a platelet and/or a fibril and/or a fiber. The at least one other component includes, e.g., a rubber (or elastomer), a thermoplastic, and/or an thermosetting resin (e.g., epoxy). The compositions can be formulated with suitable amounts of the components, with the coal derived carbon components dispersed in varying ways and in varying concentrations. As one example, the composition includes rubber (or elastomer) and a coal-derived component. As another example, the composition includes a thermoplastic and a coal-derived component. As another example, the composition includes a thermosetting resin, e.g., epoxy material and a coal-derived component. The compositions can further include optional components such as an oil (e.g., an extender oil), and/or additive(s) such as extenders, dispersants, antioxidants, or combinations thereof.

For purposes of this disclosure, and unless otherwise indicated, a “composition” includes coal derived carbon products and additives incorporated into a rubber or plastic matrix material and considers to be a composite material and include the composition and/or reaction products of two or more components.

The composition can include an amount of coal-derived component that is from about 5 wt % to about 90 wt %, such as from about 10 wt % to about 85 wt %, such as from about 15 wt % to about 80 wt %, such as from about 20 wt % to about 75 wt %, such as from about 25 wt % to about 70 wt %, such as from about 30 wt % to about 65 wt %, such as from about 35 wt % to about 60 wt %, such as from about 40 wt % to about 55 wt %, such as from about 45 wt % to about 50 wt %, based on a total weight of the composition. Higher or lower amounts of coal-derived product(s) are contemplated. In at least one embodiment, the composition includes one or more types of coal-derived products. The amount of coal-derived component can be from about 25 parts per hundred rubber (phr) to about 250 phr, such as from about 35 phr to about 200 phr, such as from about 45 phr to about 150 phr, such as from about 50 phr to about 140 phr, such as from about 60 phr to about 130 phr, such as from about 70 phr to about 120 phr, such as from about 80 phr to about 110 phr, such as from about 90 phr to about 100 phr.

The coal-derived component(s) act as a reinforcement, a filler, and/or a diluent for the compositions and can replace or be used in addition to common carbon based reinforcements/fillers/diluents derived from non-coal sources such as natural gas and oil, which includes carbon black, fibers, fibrils and in addition calcium carbonate.

The composition can include an amount of rubber and/or elastomer that is from about 5 wt % to about 90 wt %, such as from about 10 wt % to about 85 wt %, such as from about 15 wt % to about 80 wt %, such as from about 20 wt % to about 75 wt %, such as from about 25 wt % to about 70 wt %, such as from about 30 wt % to about 65 wt %, such as from about 35 wt % to about 60 wt %, such as from about 40 wt % to about 55 wt %, such as from about 45 wt % to about 50 wt %, based on a total weight of the composition. Higher or lower amounts of rubber and/or elastomer are contemplated. In at least one embodiment, the composition includes one or more types of rubber and/or elastomer.

The composition can include an amount of thermoplastic (e.g., a thermoplastic polymer or a thermoplastic polyolefin) that is from about 5 wt % to about 90 wt %, such as from about 10 wt % to about 85 wt %, such as from about 15 wt % to about 80 wt %, such as from about 20 wt % to about 75 wt %, such as from about 25 wt % to about 70 wt %, such as from about 30 wt % to about 65 wt %, such as from about 35 wt % to about 60 wt %, such as from about 40 wt % to about 55 wt %, such as from about 45 wt % to about 50 wt %, based on a total weight of the composition. Higher or lower amounts of thermoplastic are contemplated. In at least one embodiment, the composition includes one or more types of thermoplastic.

The composition can include an amount of epoxy resin that is from about 5 wt % to about 90 wt %, such as from about 10 wt % to about 85 wt %, such as from about 15 wt % to about 80 wt %, such as from about 20 wt % to about 75 wt %, such as from about 25 wt % to about 70 wt %, such as from about 30 wt % to about 65 wt %, such as from about 35 wt % to about 60 wt %, such as from about 40 wt % to about 55 wt %, such as from about 45 wt % to about 50 wt %, based on a total weight of the composition. Higher or lower amounts of rubber and/or elastomer are contemplated. In at least one embodiment, the composition includes one or more types of rubber and/or elastomer.

The composition can include an oil such as an extender oil (e.g., treated distillate aromatic extract (TDAE) oil) in an amount of 0.1 wt % or more, such as from about 1 wt % to about 20 wt %, such as from about 2 wt % to about 15 wt %, such as from about 3 wt % to about 10 wt %, such as from about 4 wt % to about 9 wt %, such as from about 5 wt % to about 8 wt %, such as from about 6 wt % to about 7 wt %, based on the total weight of the composition. Higher or lower amounts of oil are contemplated. In at least one embodiment, the composition includes one or more types of oils. The quantity of oil added can depend on the properties desired, with an upper limit that may depend on the compatibility of the particular oil and blend ingredients; and this limit can be exceeded when excessive exuding of oil occurs. The amount of oil can depend, at least in part, upon the type of rubber. In some embodiments, the amount of oil in the composition can be about 0.5 phr to about 20 phr, such as from about 1 phr to about 15 phr, such as from about 3 phr to about 10 phr, such as from about 4 phr to about 9 phr, such as from about 5 phr to about 8 phr, such as from about 6 phr to about 7 phr.

The composition can also include a curative in an amount of 0.1 wt % or more, such as from about 1 wt % to about 20 wt %, such as from about 2 wt % to about 15 wt %, such as from about 3 wt % to about 10 wt %, such as from about 4 wt % to about 9 wt %, such as from about 5 wt % to about 8 wt %, such as from about 6 wt % to about 7 wt %, based on the total weight of the composition. Higher or lower amounts of curative are contemplated. In at least one embodiment, the composition includes one or more types of curatives. Types of curatives that can be used in the compositions are provided below.

The composition can include a processing additive such as a polymeric processing additive such as a dispersant or anti-oxidant, in any amount, typically 0.1 wt % or more, such as from about 1 wt % to about 20 wt %, such as from about 2 wt % to about 15 wt %, such as from about 3 wt % to about 10 wt %, such as from about 4 wt % to about 9 wt %, such as from about 5 wt % to about 8 wt %, such as from about 6 wt % to about 7 wt %, based on the total weight of the composition. Higher or lower amounts of processing additive are contemplated. In at least one embodiment, the composition includes one or more types of polymeric processing additives.

In at least one embodiment, the composition includes one or more additive, such as colorants, pigments, anti-ozonants, antioxidants, dispersant, rubber processing oil, lubricants, antiblocking agents, waxes, nucleators, stabilizers, foaming agents, flame retardants, antistatic agents, slip masterbatches, siloxane based slip agents, ultraviolet inhibitors, antioxidants, and/or other additives known in the compounding art. These additives can be used in the compositions at an amount of about 0.1 wt % or more, such as from about 1 wt % to about 20 wt %, such as from about 2 wt % to about 15 wt %, such as from about 3 wt % to about 10 wt %, such as from about 4 wt % to about 9 wt %, such as from about 5 wt % to about 8 wt %, such as from about 6 wt % to about 7 wt %, based on the total weight of the composition. Higher or lower amounts of additives are contemplated.

### Coal-Derived Component

As discussed above, the coal-derived component can be from any suitable source such as the Powder River Basin (PRB) mines. The coal-derived component can be, e.g., a coal powder and/or derived from a coal char produced in a sustainable way using a proprietary environmentally friendly thermo-chemical process, (e.g., Patent Application WO2019/055529); which can be customized to produce coal derived carbon reinforcement and filler products to suit various composite material products and application requirements, such as variations in organic to carbon ratio and porosity by changing the volume to area ration of the produced carbon products. The coal-derived component can be customized by milling, grinding, cutting, crushing, or otherwise engineered or broken into smaller pieces prior to making the compositions described herein. Milling can be performed by suitable methods in the art in order to pulverize and dry the coal prior to use in the compositions. The coal-derived component can be in the form of nanoparticles, microparticles, macroparticles, platelets, and/or spheroidal beads and particles.

The bulk coal-derived component can be untreated or treated and similarly the surface can be treated or untreated. The untreated coal-derived components can be used in the compositions described herein after mechanical processing such as milling to a desired particle size. When the coal-derived component is desired to have different bulk properties, then the organic to carbon content can be varied, and the carbon used dried or water wet. When the coal-derived component is desired to have, e.g., different surface and/or interfacial properties in the compositions, the coal-derived component can be treated by a variety of suitable physical and/or chemical treatment methods such as gas-phase plasma treatment, fluidized bed treatment, etching, ion bombardment, and/or wet chemical processes. The coal-derived component can be milled before or after such treatment(s).

The various treatments can be used to activate and/or adjust the properties of the coal-derived component, such as surface areas, porosity, ash content, moisture content, among other properties. The treatment(s) can also remove other materials such as volatiles and mineral matter, and treated to remove varying degrees of impurities from the coal-derived components to suit need and performance. Treatment can also change the performance properties such as modulus and tensile strength of the resulting rubber composition, thermoplastic composition or other composition having the treated carbon-derived component therein, where electrical properties may be varied too. For example, the coal-derived component can be mixed with a dehydrating agent such as zinc chloride, phosphoric acid, and/or sulfuric acid at elevated temperatures of about 150° C. to about 700° C. Such chemical treatment aids in the removal of moisture and changes the surface area of the coal-derived component. As another example, surface oxides can be produced by heating the coal-derived component at temperatures above 800° C. (such as from about 800° C. to about 1,000° C.), then exposing them to air at a temperature of 340° C. to about 450° C.

In some examples, the coal-derived component is ground or milled to a predetermined particle size suitable for a desired application. The coal-derived component can then be activated by thermal treatment and/or chemical treatment, if desired. Apparatus to mill or grind the coal can be in the form of a ball mill, rod mill (or slitting mill), autogenous mill, pebble mill, semi-autogenous grinding mill, high pressure grinding roller, buhrstone mill, tower mill, vertical shaft impactor mill, or other suitable apparatus. The mill can also act to separate the ground particles to specific sizes such as micron size. Aggregate milling processes can also be used to remove or separate contaminants (e.g., inorganic materials, undesired organic materials, and/or moisture) from the coal-derived component.

The coal-derived component can be porous, substantially porous, non-porous, or substantially non-porous (e.g., having near-zero porosity). The coal powder (CP) can be made by recovering mined coal and either mechanically or chemically breaking down the raw coal into smaller pieces to the desired size which can be nano-meters, millimeters in size. For example, the coal powder is made by taking a lump of raw coal and pulverizing it using mechanical grinding wheels, thereafter using the produced material as is or solvent treating the bulk material to provide a high carbon content residual or extract or alternatively mildly heating the coal under pyrolysis conditions to modify porosity, remove water and organic material. Each of these processing steps alone or together will produce a carbon reinforcement or filler of different properties and behavior, thereby providing the ability to customize the types of carbon product produced.

The coal char useful for embodiments described herein is typically a solid material that remains after light gases and other materials such as tar have been substantially removed from the coal during pyrolysis, carbonization, or similar processes. The coal char can be made by any suitable method. For example, the coal char is made by placing raw coal particles in a reactor and thermally heating to a temperature between 220° C. and 780° C., whereby organics and water present are driven off to produce a porous carbon product. The environment in which this pyrolysis process occurs can be in air, in the presence of an inert gas, or a hydrogen rich gas. The residence time for the reaction can vary between 1 minute and 3 hours. (see patent application WO2019/055529, which is incorporated herein by reference).

The coal-derived component can exhibit one or more of the following characteristics:
(a) An external surface area that can be about 200 m²/g or less, such as about 160 m²/g or less, such as from about 2 m²/g to about 150 m²/g, such as from about 5 m²/g to about 140 m²/g, such as from about 10 m²/g to about 120 m²/g, such as from about 20 m²/g to about 100 m²/g, such as from about 40 m²/g to about 80 m²/g, such as from about 50 m²/g to 70 m²/g as measured by the statistical thickness method (STSA, described below). In at least one embodiment, the external surface area is from about 1 m²/g to about 40 m²/g, from about 15 m²/g to about 60 m²/g, from about 60 m²/g to about 110 m²/g, or from about 80 m²/g to about 160 m²/g as measured by STSA. In some embodiments, the external surface area is from about 1 m²/g to about 20 m²/g, such as from about 2 m²/g to about 19 m²/g, such as from about 2 m²/g to about 18 m²/g, such as from about 4 m²/g to about 17 m²/g, such as from about 5 m²/g to about 16 m²/g, such as from about 6 m²/g to about 15 m²/g, such as from about 7 m²/g to about 14 m²/g, such as from about 8 m²/g to about 13 m²/g, such as from about 9 m²/g to about 12 m²/g, such as from about 10 m²/g to about 11 m²/g as measured by STSA. Higher or lower external surface areas as measured by STSA are contemplated.
(b) A Brunauer, Emmett and Teller (BET) surface area that can be less than about 2000 m²/g, such as less than about 1500 m²/g, such as less than about 900 m²/g, such as from about 100 m²/g to about 800 m²/g, such as from about 150 m²/g to about 600 m²/g, such as from about 200 m²/g to about 550 m²/g, such as from about 250 m²/g to about 500 m²/g, such as from about 300 m²/g to about 450 m²/g, such as from about 350 m²/g to about 450 m²/g. In some embodiments, the coal-derived component can have a BET surface area of less than 10 m²/g. Higher or lower BET surface areas are contemplated. The BET surface area is based on the nitrogen surface area (NSA) method described below.
(c) An average particle size that can be about 2000 μm or less, such as about 1000 μm or less, such as about 900 μm or less, such as about 800 μm or less, such as about 700 μm or less, such as about 600 μm or less, such as about 500 μm or less, such as about 400 μm or less, such as about 300 μm or less, such as about 200 μm or less, such as from about 1 μm to about 150 μm, such as from about 5 μm to about 145 μm, such as from about such as from about 10 μm to about 140 μm, such as from about 15 μm to about 135 μm, such as from about such as from about 20 μm to about 130 μm, such as from about 25 μm to about 125 μm, such as from about such as from about 30 μm to about 120 μm, such as from about 35 μm to about 115 μm, such as from about such as from about 40 μm to about 110 μm, such as from about 45 μm to about 105 μm, such as from about such as from about 50 μm to about 100 μm, such as from about 55 μm to about 95 μm, such as from about such as from about 60 μm to about 90 μm, such as from about 65 μm to about 85 μm, such as from about such as from about 70 μm to about 80 μm. In some embodiments, the average particle size can be about 0.1 μm to about 100 μm, such as from about 0.5 μm to about 10 μm, or about 0.1 μm to about 2 μm. Higher or lower average particle sizes are contemplated.
(d) A total pore volume that can be about 0.1 cm³/g or more, such as about 0.15 cm³/g or more, such as from about 0.15 cm³/g to about 0.5 cm³/g. Higher or lower total pore volumes are contemplated.
(e) the mineral content can vary between zero and 12%. Other mineral content values are contemplated.
(f) the moisture content can vary between zero and 28%, or more dependent on the originating water content of the raw coal. Other moisture contents are contemplated.
(g) the organic content can vary between zero and 40%. Other values for organic content are contemplated.

The external surface area of the coal-derived product can influence its performance and use in compositions and the amount included to deliver desired properties. As non-limiting examples, and in the field of tires, compositions useful for tire carcasses typically include fillers/diluents having STSA values of about 60 m²/g or less, while the compositions useful for tire treads typically include fillers/diluents of about 60 m²/g to about 160 m²/g. Higher or lower values are contemplated

### Elastomer/Rubber Component

The compositions can include an elastomer. The elastomers that can be used include natural and synthetic rubbers. Reference to elastomer may include mixtures of more than one elastomer. Reference to elastomer also includes rubber, unless the context indicates otherwise.

The elastomer or rubber can be non-crosslinked, crosslinked, or partially crosslinked. Reference to a rubber may include mixtures of more than one rubber. Reference to elastomer may include mixtures of more than one elastomer. Rubbers that may be employed to form the rubber phase include those polymers that are capable of being cured or crosslinked by a phenolic resin or a hydrosilylation curative (e.g., silane-containing curative), a peroxide with a coagent, a moisture cure via silane grafting, or an azide.

Non-limiting examples of rubbers and elastomers include styrene-based rubbers, such as styrene-butadiene rubbers (SBR) such as styrenic-block copolymers (SBC), styrene-butadiene-styrene copolymers (SBS), hydrogenated styrenic copolymer such as styrene-ethylene-butylene-styrene copolymers (SEBS), styrene-ethylene-ethylene-propylene-styrene copolymers (SEEPS), olefinic elastomeric terpolymers, nitrile rubbers, butyl rubbers (such as isobutylene-isoprene rubber (IIR), brominated isobutylene-isoprene rubber (BIIR), and isobutylene paramethyl styrene rubber (BIMSM), polyisobutylene rubber (PIB)), natural rubbers, ethylene propylene rubbers (EPR), acrylic rubbers such as alkyl acrylate copolymers (ACM), and combinations thereof. Other useful rubbers or elastomers include those deriving from the polymerization of conjugated diene monomers, the copolymerization of conjugated diene monomers with other monomers such as vinyl-substituted aromatic monomers, or the copolymerization of ethylene with one or more α-olefins and optionally one or more diene monomers.

In some embodiments, the rubber or elastomer component can include a styrene-mono(lower)olefin-styrene, or, styrene-isoprene-styrene, or a styrene-butadiene-styrene block copolymer. The rubber or elastomer component can have a hardness in the range from Shore A 30 up to Shore A 100, though higher or lower values are contemplated.

A weight average molecular weight (Mw) of the rubber or elastomer can be about 100,000 g/mol or more, such as about 200,000 g/mol or more, such as about 400,000 g/mol or more, such as about 600,000 g/mol or more. In these or other embodiments, the Mw can be about 1,200,000 g/mol or less, such as about 1,000,000 g/mol or less, such as about 900,000 g/mol or less, such as about 800,000 g/mol or less. In these or other embodiments, the Mw can be from about 500,000 g/mol to about 3,000,000 g/mol, such as from about 500,000 g/mol to about 2,000,000, such as from about 500,000 g/mol to about 1,500,000 g/mol, such as from about 600,000 g/mol to about 1,200,000 g/mol, such as from about 600,000 g/mol to about 1,000,000 g/mol. Higher or lower values are contemplated.

Some styrene-butadiene elastomers and rubbers that are useful for embodiments described herein include those from manufacturers such as Firestone, Dynasol, Eni, Asahi-Kasei, LG Chem, GoodYear, JSR, and Lanxess.

Other elastomeric materials that can be utilized include those commercially available under the tradenames VISTALON™ (ExxonMobil Chemical Co.; Houston, Tex.), KELTAN™ (DSM Copolymers), NORDEL™ IP (Dow), NORDEL MG™ (Dow), ROYALENE™ (Lion Copolymer) and BUNA™ (Lanxess).

In some embodiments, the elastomer can be highly cured. In some embodiments, the elastomer can be advantageously partially or fully (completely) cured. In some embodiments, the elastomer can be advantageously not cured or crosslinked. The degree of cure can be measured by determining the amount of elastomer that is extractable from the composition by using cyclohexane or boiling xylene as an extractant. This method is disclosed in U.S. Pat. No. 4,311,628, which is incorporated herein by reference for purposes of U.S. patent practice. In some embodiments, the elastomer can have a degree of cure where not more than about 5.9 wt %, such as not more than about 5 wt %, such as not more than about 4 wt %, such as not more than about 3 wt % is extractable by cyclohexane at 23° C. as described in U.S. Pat. Nos. 5,100,947 and 5,157,081, which are incorporated herein by reference for purpose of U.S. patent practice. In these or other embodiments, the elastomer can be cured to an extent where greater than about 94 wt %, such as greater than about 95 wt %, such as greater than about 96 wt %, such as greater than about 97 wt % by weight of the elastomer is insoluble in cyclohexane at 23° C.

Despite the fact that the elastomer may be partially or fully cured, the compositions of this disclosure can be processed and reprocessed by conventional plastic processing techniques such as extrusion, injection molding, blow molding, and compression molding. The elastomer within these thermoplastic elastomers can be in the form of finely-divided and well-dispersed particles of vulcanized or cured elastomer within a continuous thermoplastic phase or matrix. In some embodiments, a co-continuous morphology or a phase inversion can be achieved.

### Thermoplastic Component

The composition can include a thermoplastic component (e.g., one or more thermoplastic polymers and/or one or more thermoplastic polyolefins). Illustrative, but non-limiting, examples of thermoplastic polymers include polyethylene (homopolymer, random copolymer), polypropylene (e.g., homopolymer, random copolymer), cyclic olefin copolymer, polyphenylene oxide (PPO) blended with polypropylene, polybutylene terephthalate, syndiotactic polystyrene, polyethylene terephthalate, acrylonitrile butadiene styrene, acrylonitrile styrene acrylate, polyetherimide, polyamide, polymethylpentene polymethylpentene resin (such as a homopolymer or copolymer, e.g., a homopolymer or copolymer of 4-methyl-1-pentene), or combinations thereof.

In some embodiments, the thermoplastic component includes at least one thermoplastic polyolefin such as an ethylene-based polymer (e.g., a polyethylene, such as a homopolymer, copolymer, or combinations thereof), a propylene-based polymer (e.g., polypropylene, such as a homopolymer, a random copolymer, impact copolymer, or combinations thereof), a butene-based polymer (e.g., a polybutene and/or a polybutene-1), or combinations thereof, in any suitable proportions.

Ethylene-based polymers can include those resins that primarily include units derived from the polymerization of ethylene. In some embodiments, at least 90%, or at least 95%, or at least 99% of the units of the ethylene-based polymer can derive from the polymerization of ethylene, based on a total weight of the ethylene-based polymer. In at least one embodiment, the ethylene-based polymer has an ethylene content greater than about 30 wt %, such as about 40 wt % or more, such as about 50 wt % or more, such as from about 50 wt % to about 100 wt %, such as from about 55 wt % to about 95 wt %, such as from about 60 wt % to about 90 wt %, such as from about 65 wt % to about 85 wt %, such as from about 70 wt % to about 80 wt %, based on a total weight of the ethylene-based polymer. Higher or lower values are contemplated.

In particular embodiments, these polymers can include homopolymers of ethylene and/or copolymers of ethylene. Such copolymers of ethylene include ethylene and one or more monomer units. Suitable monomer units can include, but are not limited to, ethylene and/or higher alpha-olefins ranging from C₄ to C₂₀ (e.g., C₁-C₁₀ alpha-olefins), such as, for example, 1-butene, 1-hexene, 1-octene, 1-decene, 2-methyl-1-propene, 3-methyl-1-pentene, 4-methyl-1-pentene, 5-methyl-1-hexene, or mixtures thereof. Monomer units also include olefins having more than one double bond, e.g., dienes, trienes, etc (C₄ to C₂₀ olefins).

The ethylene-based polymer can have a weight average molecular weight (Mw) that is about 100,000 g/mol or more, such as about 200,000 g/mol or more, such as about 400,000 g/mol or more, such as about 600,000 g/mol or more. In these or other embodiments, the Mw can be about 1,200,000 g/mol or less (such as about 1,000,000 g/mol or less, such as about 900,000 g/mol or less, such as about 800,000 g/mol or less, such as from about 400,000 g/mol to about 700,000 g/mol). In these or other embodiments, the Mw can be from about 400,000 g/mol and about 3,000,000 g/mol (such as from about 400,000 g/mol to about 2,000,000, such as from about 400,000 g/mol to about 1,500,000 g/mol, such as from about 400,000 g/mol to about 1,000,000 g/mol or from about 600,000 g/mol to about 1,200,000 g/mol, such as from about 600,000 g/mol to about 1,000,000 g/mol), as measured by GPC with polystyrene standards. Higher or lower values are contemplated.

The ethylene-based polymer can include a low density polyethylene (LDPE), a linear low density polyethylene (LLDPE), an ultra low density polyethylene (ULDPE), a linear very low density polyethylene (VLDPE), a high density polyethylene (HDPE), a homogeneously branched linear ethylene polymer, a homogeneously branched substantially linear ethylene polymer (that is homogeneously branched long chain branched ethylene polymers), and combinations thereof. In some embodiments, the ethylene-based polymer can be a high melt strength long chain branched homopolymer polyethylene. The ethylene-based polymers may be synthesized by using an appropriate polymerization technique known in the art such as the conventional Ziegler-Natta type polymerizations, and catalysis employing single-site organometallic catalysts including metallocene catalysts. The low density polyethylene can have a density from about 0.91 g/cm³ to about 0.94 g/cm³. The high density polyethylene can have a density of about 0.94 g/cm³ to about 0.97 g/cm³.

Commercial examples of suitable ethylene-based polymers include, but are not limited to, ATTANE™, INNATE™, Affinity, DOWLEX™, ELITE™, all available from The Dow Chemical Company of Midland, MI; and EXCEED™, ENABLE™, and EXACT™ available from ExxonMobil of Houston, TX. Other ethylene-based polymers can be used.

Propylene-based polymers can include those resins that primarily include units deriving from the polymerization of propylene. In some embodiments, at least about 75%, or at least about 90%, or at least about 95%, or at least about 97% of the units of the propylene-based polymer can derive from the polymerization of propylene, based on a total weight of the propylene-based polymer. In at least one embodiment, the propylene-based polymer has a propylene content greater than about 30 wt %, such as about 40 wt % or more, such as about 50 wt % or more, such as from about 50 wt % to about 100 wt %, such as from about 55 wt % to about 95 wt %, such as from about 60 wt % to about 90 wt %, such as from about 65 wt % to about 85 wt %, such as from about 70 wt % to about 80 wt %, based on a total weight of the propylene-based polymer. Higher or lower values are contemplated.

In particular embodiments, these polymers can include homopolymers of propylene and copolymers of propylene. Homopolymer polypropylene can include linear chains and/or chains with long chain branching.

When used, the propylene-based copolymer includes at least two different types of monomer units, one of which is propylene. Suitable monomer units can include, but are not limited to, ethylene and/or higher alpha-olefins ranging from C₄ to C₂₀ (e.g., C₁-C₁₀ alpha-olefins), such as, for example, 1-butene, 1-hexene, 1-octene, 1-decene, 2-methyl-1-propene, 3-methyl-1-pentene, 4-methyl-1-pentene, 5-methyl-1-hexene, or mixtures thereof. Monomer units also include olefins having more than one double bond, e.g., dienes, trienes, etc (such as C₄ to C₂₀ olefins).

Impact and random copolymers of propylene with ethylene and/or higher α-olefins, described above, can be used. The propylene-based polymers may be synthesized by using an appropriate polymerization technique known in the art such as the conventional Ziegler-Natta type polymerizations, and catalysis employing single-site organometallic catalysts including metallocene catalysts.

The propylene-based polymer can have a weight average molecular weight (Mw) from about 50,000 g/mol to about 2,000,000 g/mol, such as from about 100,000 g/mol to about 1,000,000 g/mol, such as from about 100,000 g/mol to about 600,000 g/mol or from about 400,000 g/mol to about 800,000 g/mol, as measured by GPC with polystyrene standards. Higher or lower values are contemplated.

Examples of propylene-based polymers useful for compositions described herein include ACHIEVE™ and VISTAMAXX™, both available from ExxonMobil of Houston, TX, and VERSIFY™ from The Dow Chemical Company of Midland, MI. Other propylene-based polymers can be used.

### Other Components of the Compositions

The composition may include a plasticizer such as an oil, such as a mineral oil, a synthetic oil, or combinations thereof. These oils may also be referred to as plasticizers or extenders, and can be synthetic or natural. When used, the composition can include an amount of plasticizer or oil of about 30 wt % or less, such as from about 0.5 wt % to about 25 wt %, such as from about 1 wt % to about 20 wt %, such as from about 3 wt % to about 15 wt %, such as from about 4 wt % to about 12 wt %, based on a total weight of the composition. In some examples, the amount of oil or plasticizer can be about 250 phr or less, such as about 200 phr or less, such as about 150 phr or less, such as from about 25 phr to about 150 phr, such as from about 50 phr to about 125 phr, such as from about 75 phr to about 100 phr. In some embodiments, 50 phr or less, such as from about 1 phr to about 30 phr, such as from about 5 phr to about 25, such as from about 7.5 phr to about 20 phr, such as from about 10 phr to about 15 phr. Higher or lower amounts of plasticizer or oil can be used.

Mineral oils may include aromatic, naphthenic, paraffinic, and isoparaffinic oils, synthetic oils, and combinations thereof. The mineral oils may be treated or untreated. Useful mineral oils can be obtained under the tradename SUNPAR™ (Sun Chemicals). Other oils are available under the tradename PARALUX™ (Chevron), and PARAMOUNT™ (Chevron) such as Paramount™ 6001R (Chevron Phillips). Other oils that may be used include hydrocarbon oils and plasticizers, such as organic esters and synthetic plasticizers. Many additive oils are derived from petroleum fractions, and have particular ASTM designations depending on whether they fall into the class of paraffinic, naphthenic, or aromatic oils. Other types of additive oils include alpha olefinic synthetic oils, such as liquid polybutylene. Additive oils other than petroleum based oils can also be used, such as oils derived from coal tar and pine tar, as well as synthetic oils, e.g., polyolefin materials.

Other types of additive oils can include alpha olefinic synthetic oils, such as liquid polybutylene and polyisobutylene. Additive oils other than petroleum based oils can also be used, such as oils derived from coal tar and pine tar, as well as synthetic oils, e.g., polyolefin materials. Other plasticizers can include triisononyl trimellitate (TINTM). In addition, vegetable or animal oils may be also used as plasticizer and/or processing aid in the composition.

Examples of oils can include base stocks. According to the American Petroleum Institute (API) classifications, base stocks are categorized in five groups based on their saturated hydrocarbon content, sulfur level, and viscosity index. Lube base stocks are typically produced in large scale from non-renewable petroleum sources. Group I, II, and III base stocks are all derived from crude oil via extensive processing, such as solvent extraction, solvent or catalytic dewaxing, and hydroisomerization, hydrocracking and isodewaxing, isodewaxing and hydrofinishing. Group III base stocks can also be produced from synthetic hydrocarbon liquids obtained from natural gas, coal or other fossil resources. Group IV base stocks are polyalphaolefins (PAOs), and are produced by oligomerization of alpha olefins, such as 1-decene. Group V base stocks include all base stocks that do not belong to Groups I-IV, such as naphthenics, polyalkylene glycols (PAG), and esters.

In some embodiments, synthetic oils can include polymers and oligomers of butenes including isobutene, 1-butene, 2-butene, butadiene, and mixtures thereof. In some embodiments, these oligomers can be characterized by a number average molecular weight (Mn) of from about 300 g/mol to about 9,000 g/mol, and in other embodiments from about 700 g/mol to about 1,300 g/mol. In some embodiments, these oligomers can include isobutenyl mer units. Exemplary synthetic oils can include polyisobutylene, poly(isobutylene-co-butene), and mixtures thereof. Exemplary polyisobutylenes can include liquid polyisobutylene oils having an Mn in the range of from about 600 g/mol to about 6,000 g/mol and from about 20 phr (parts by weight per 100 parts of block copolymer) to 100 phr of polyolefin hardener. In some embodiments, synthetic oils may include polylinear α-olefins, poly-branched α-olefins, hydrogenated polyalphaolefins, and mixtures thereof.

Other oils suitable for use include, for example, rubber processing oils (including paraffinic mineral oils, mild extraction solvate (IVIES) oils, distillate aromatic extract (DAE) oils, treated distillate aromatic extract (TDAE) oils, residual aromatic extract (RAE) oils, treated residual aromatic extract (TRAE) oils, special residual aromatic extract (SRAE) oils, naphthenic oils, heavy naphthenic oils, and combinations thereof), extending oils for polyolefins, rubber processing waxes (including polyethylene waxes, montan wax, paraffin wax, beeswax, rice wax, carnauba wax, lanolin wax, and combinations thereof), and combinations thereof.

Useful synthetic oils, if used, can be commercially obtained under the tradenames POLYBUTENE™ (Soltex; Houston, Tex.), and INDOPOL™ (Ineos). White synthetic oil is available under the tradename SPECTRASYN™ and ELEVAST™ from ExxonMobil (ExxonMobil), RISELLA™ X (Shell), PRIMOL™ (Exxonmobil), MARCOL™ (Exxonmobil), and DRAKEOL™ (Pencero) series of white oils, or combinations thereof. Other oils can also be employed.

In some embodiments, the addition of certain low to medium molecular weight (<10,000 g/mol) organic esters and alkyl ether esters to the present compositions can lower the Tg of the polyolefin and rubber components and of the overall composition. The addition of certain low to medium molecular weight (<10,000 g/mol) organic esters and alkyl ether esters can improve the low temperature properties, particularly flexibility and strength. Particularly suitable esters can include monomeric and oligomeric aliphatic esters having a low molecular weight, such as an average molecular weight in a range from about 2000 or below, such as about 600 or below. The esters can include monomeric alkyl monoesters, monomeric alkyl diesters, oligomeric alkyl monoesters, oligomeric alkyl diesters, monomeric alkylether monoesters, monomeric alkylether diesters, oligomeric alkylether monoesters, oligomeric alkylether diesters, and mixtures thereof. Higher or lower values are contemplated.

Examples of esters suitable for use in the present compositions include diisooctyldodecanedioate, dioctylsebacate, butoxyethyloleate, n-butyloleate, n-butyltallate, isooctyloleate, isooctyltallate, dialkylazelate, diethylhexylsebacate, alkylalkylether diester glutarate, oligomers thereof, and mixtures thereof. Other analogues useful in the present compositions include alkyl alkylether monoadipates and diadipates, monoalkyl and dialkyl adipates, glutarates, sebacates, azelates, ester derivatives of castor oil or tall oil, and oligomeric monoesters and diesters or monoalkyl and dialkyl ether esters therefrom. Isooctyltallate and n-butyltallate can be useful. These esters may be used alone in the compositions, or as mixtures of different esters, or they may be used in combination with conventional hydrocarbon oil diluents or processing oils, e.g., paraffin oil. In certain embodiments, the amount of ester plasticizer in the composition can be from about 0.1 wt % to about 10 wt % based upon a total weight of the composition. Higher or lower values are contemplated.

In some examples, an additional reinforcement, filler, and/or diluent besides the coal-derived component can be used such as clays, carbon black, silica, talc, titanium dioxide, a nucleating agent, mica, wood flour, and combinations thereof can be present in the composition in an amount of about 0.1 wt % to about 10 wt %, such as from about 0.5 wt % to about 9 wt %, such as from about 1 wt % to about 8 wt %, such as from about 2 wt % to about 7 wt %, such as from about 3 wt % to about 6 wt %, such as from about 4 wt % to about 5 wt %, based on the total weight of the composition. Higher or lower amounts of filler(s) are contemplated. In at least one embodiment, the composition includes one or more types of fillers. In some embodiments, the amount of additional filler in the composition can be about 0.5 phr to about 20 phr, such as from about 1 phr to about 15 phr, such as from about 3 phr to about 10 phr, such as from about 4 phr to about 9 phr, such as from about 5 phr to about 8 phr, such as from about 6 phr to about 7 phr.

Other materials and additives that can be used for the compositions described herein are discussed below.

### Preparation of the Compositions

As noted above, the compositions described herein include various compositions such as elastomer compositions, rubber compositions, and vulcanizable elastomeric compositions containing a coal-derived component. The elastomer compositions, rubber compositions, and vulcanizable elastomeric containing a coal derived component can additionally include a thermoplastic component, an epoxy component, an oil, and/or additive(s). Further characteristics of such compositions and preparation thereof are now described.

The composition can be partially or fully cured or crosslinked by, e.g., vulcanization or dynamic vulcanization. Vulcanization is typically a process in which a rubber or elastomer is treated and converted to a material with different properties. Dynamic vulcanization is typically a process in which a rubber or elastomer is blended with a thermoplastic and/or epoxy and converted to a material with different properties.

The can be cured or vulcanized with or without the thermoplastic and/or epoxy under, e.g., conditions of high shear at a temperature above the melting point of the rubber (or elastomer), the thermoplastic, and/or the epoxy. A variety of curatives can be used, such as phenolic resin cure systems, peroxide cure systems, and silicon-containing cure systems, such as hydrosilylation and silane grafting/moisture cure.

Vulcanization or dynamic vulcanization can occur in the presence of the thermoplastic and/or epoxy, or the thermoplastic and/or epoxy can be added after dynamic vulcanization (e.g., post added), or both (e.g., some thermoplastic and/or epoxy can be added prior to dynamic vulcanization and some thermoplastic and/or epoxy can be added after dynamic vulcanization). In some embodiments, the rubber or elastomer is crosslinked and/or dispersed as fine particles within the thermoplastic. In some embodiments, the rubber or elastomer is not cured or crosslinked.

The compositions can be made by the following method in a reactor. The rubber and/or elastomer are introduced to the reactor and then heated at a desired temperature. Following this, a curative is introduced and curing of the rubber proceeds. Oil may be injected into the reactor at various points before, during, and/or after the vulcanization operation. The coal-derived component may be introduced with the rubber and/or elastomer before and/or after the vulcanization. When the coal-derived component is introduced to the vulcanizate after the vulcanization operation, the introduction can occur while the composition remains in its molten state after vulcanization, or the vulcanizate can be cooled (e.g., pelletized) and subsequently re-processed and returned to a molten state at which time the coal-derived component can be added. In some embodiments, the coal-derived component may be introduced to the blend or vulcanizate as a mixture or masterbatch with a resin or oil. Optional additives such as fatty acids, antioxidants and so forth can be introduced before and/or after the vulcanization operation. In some embodiments, the optional additive(s) are introduced to the vulcanizate after vulcanization. The introduction of the optional additive(s) may occur while the composition remains in its molten state after vulcanization, or the vulcanizate can be cooled (e.g., pelletized) and subsequently re-processed and returned to a molten state at which time the optional additive(s) can be added. In one or more embodiments, one or more constituents of the optional additive(s) may be introduced to the vulcanizate as a mixture or masterbatch with one or more other ingredients of the optional additive(s) and/or together with an inert carrier such as a resin or oil.

The method can be performed in a continuous mixing reactor also referred to as a continuous mixer. Continuous mixing reactors include those reactors that can be continuously fed ingredients and that can continuously have product removed therefrom. Illustrative, but non-limiting, examples of continuous mixing reactors include twin screw or multi-screw extruders (e.g., ring extruder). Methods employing high and low shear rates can be utilized. The temperature of the mixture or blend as it passes through the various barrel sections or locations of a continuous reactor can be varied as is known in the art. In particular, the temperature within the cure zone may be controlled or manipulated according to the half-life of the curative employed.

When the composition is made with a thermoplastic along with the rubber and/or elastomer, the thermoplastic and the rubber and/or elastomer are introduced to the reactor. These components can then be mixed at a temperature above the melt temperature of the thermoplastic resin. Following this initial mixing, a curative is introduced to the blend and curing of the rubber proceeds. Oil may be injected into the reactor at various points before, during, and/or after the vulcanization or phase inversion operation. The coal-derived component may be introduced with the thermoplastic and rubber and/or elastomer before and/or after the vulcanization. When the coal-derived component is introduced to the vulcanizate after the vulcanization operation, the introduction can occur while the composition remains in its molten state after vulcanization, or the vulcanizate can be cooled (e.g., pelletized) and subsequently re-processed and returned to a molten state at which time the coal-derived component can be added. In some embodiments, the coal-derived component may be introduced to the blend or vulcanizate as a mixture or masterbatch with a resin or oil. Optional additives such as fatty acids, antioxidants and so forth can be introduced before and/or after the vulcanization operation. In some embodiments, the optional additive(s) are introduced to the vulcanizate after vulcanization. The introduction of the optional additive(s) may occur while the composition remains in its molten state after vulcanization, or the vulcanizate can be cooled (e.g., pelletized) and subsequently re-processed and returned to a molten state at which time the optional additive(s) can be added. In one or more embodiments, one or more constituents of the optional additive(s) may be introduced to the vulcanizate as a mixture or masterbatch with one or more other ingredients of the optional additive(s) and/or together with an inert carrier such as a resin or oil. The method can be performed in a occur in a continuous mixing reactor as described above.

A process for the preparation of the composition can include melt processing under shear conditions of one or more curing agents with the rubber (or elastomer), and optionally the thermoplastic, epoxy, and/or additive. In some embodiments, the melt processing can be performed under high shear conditions or low shear conditions. Shear conditions are similar to conditions that exist when the compositions are produced using common melt processing equipment such as Brabender or Banbury mixers (lab scale instruments) and commercial twin-screw extruders.

As noted above, the compositions can be vulcanized or dynamically vulcanized by a variety of methods including employing a cure system, wherein the cure system comprises a curative, such as a sulfur curative, phenolic resin curative, a peroxide curative, a maleimide curative, a hexamethylene diamine carbamate curative, a silicon-based curative (including hydrosilylation curative, a silane-based curative such as a silane grafting followed by moisture cure), metal oxide-based curative (such as ZnO), sulfur-based curative, or combinations thereof.

The compositions can be cured in a conventional manner with known vulcanizing agents at an amount of about 0.1 phr to 30 phr. Higher or lower values are contemplated.

The vulcanization can be conducted in the presence of a sulfur vulcanizing agent. Examples of suitable sulfur vulcanizing agents include “rubbermaker's” soluble sulfur, sulfur donating vulcanizing agents, such as an amine disulfide, polymeric polysulfide or sulfur olefin adducts; and insoluble polymeric sulfur. Preferably, the sulfur vulcanizing agent is soluble sulfur or a mixture of soluble and insoluble polymeric sulfur. When the sulfur vulcanizing agent is used, it can be used in an amount of about 30 phr or less, such as about 25 phr or less, such as about 20 phr or less, such as about 15 phr or less, such as from about 0.1 phr to about 10, such as from about 0.5 phr to about 7.5 phr, such as from about 1 phr to about 5 phr, such as from about 1.5 to about 5 phr. Higher or lower values are contemplated.

When a metal-oxide based curative (e.g., ZnO) is utilized, an amount of metal-oxide based curative can be from about 0.1 phr to about 15 phr, such as from about 0.5 phr to about 10 phr, such as from about 1 phr to about 9 phr, such as from about 2 phr to about 8 phr, such as from about 3 phr to about 7 phr, such as from about 4 phr to about 6 phr. In at least one embodiment, the amount of ZnO is about 0.1 phr to about 5 phr. Higher or lower values are contemplated.

Phenolic resin curatives can include resole resins, which may be made by the condensation of alkyl substituted phenols or unsubstituted phenols with aldehydes, such as formaldehydes, in an alkaline medium or by condensation of bi-functional phenoldialcohols. The alkyl substituents of the alkyl substituted phenols may contain between about 1 and about 10 carbon atoms, such as dimethylolphenols or phenolic resins, substituted in para-positions with alkyl groups containing between about 1 and about 10 carbon atoms. Higher or lower values are contemplated. In some embodiments, the phenolic resin can be used in combination with a halogen source, such as stannous chloride, and metal oxide or reducing compound such as zinc oxide.

The phenolic resin may be employed in an amount from about 1 phr to about 10 phr, such as from about 1.5 phr to about 8 phr, such as from about 2 phr to about 6 phr, such as from about 3 phr to about 5 phr, such as from about 4 phr to about 5 phr. In some embodiments, the phenolic resin can be employed in conjunction with stannous chloride and optionally zinc oxide. Stannous chloride can be used at an amount of about 0.1 phr to about 10 phr, such as from about 1 phr to about 1.5 phr, such as from about 1.2 phr to about 1.3 phr. The zinc oxide (ZnO) can be used in an amount from about 0.1 phr to about 15 phr, such as from about 0.5 phr to about 10 phr, such as from about 1 phr to about 5 phr, such as from about 2 phr to about 4 phr. Higher or lower values are contemplated.

In some embodiments, useful peroxide curatives include organic peroxides. Examples of organic peroxides include, but are not limited to, di-tert-butyl peroxide, dicumyl peroxide, t-butylcumyl peroxide, α,α-bis(tert-butylperoxy) diisopropyl benzene, 2,5-dimethyl-2,5-di(t-butylperoxy)hexane (DBPH), 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, 2,5-dimethyl-2,5-di(tert-butylperoxy) hexyne-3, and mixtures thereof. Also, diaryl peroxides, ketone peroxides, peroxydicarbonates, peroxyesters, dialkyl peroxides, hydroperoxides, peroxyketals, and combinations thereof.

In some embodiments, the peroxide curatives can be employed in conjunction with a coagent. Examples of coagents can include triallylcyanurate, triallyl isocyanurate, triallyl phosphate, sulfur, N-phenyl bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, and oximes such as quinone dioxime. In order to maximize the efficiency of peroxide/coagent crosslinking, the mixing and vulcanization (and/or dynamic vulcanization) may be carried out in a nitrogen atmosphere.

In some embodiments, silicon-containing cure systems may include silicon hydride compounds having at least two Si—H groups. Silicon hydride compounds that are useful in practicing the present disclosure include methylhydrogenpolysiloxanes, methylhydrogendimethylsiloxane copolymers, alkylmethyl-co-methylhydrogenpolysiloxanes, bis(dimethylsilyl)alkanes, bis(dimethylsilyl)benzene, and mixtures thereof. Useful catalysts for hydrosilylation can include transition metals of Group VIII. These metals can include Pt, Pd, and/or Rh, well as complexes of these metals.

In some embodiments, the silicon or silane-containing compounds used for cure systems may be employed in an amount from about 0.5 parts by weight to about 10 phr, such as from about 1 phr to about 9 phr, such as from about 1 phr to about 9 phr, such as from about 2 phr to about 8 phr, such as from about 3 phr to about 7 phr, such as from about 4 phr to about 6 phr. A complementary amount of catalyst may include from about 0.5 parts of metal to about 20 parts of metal per million parts by weight of the rubber, such as from about 1 to about 10 parts of metal per million parts by weight of the rubber, such as from about 1 to about 5 or from about 1 to about 2 parts of metal per million parts by weight of the rubber to about 2.0. Higher or lower values are contemplated.

Combinations of one or more curatives can be utilized, such as ZnO and a sulfur vulcanizing agent.

The compositions described herein can be compounded by suitable methods, such as mixing the materials (e.g., the rubber, elastomer, thermoplastic, and/or epoxy) with various additive materials such as, for example, curing agents, activators, retarders and accelerators, colorants, lubricants, antiblocking agents, waxes, nucleators, stabilizers, foaming agents, flame retardants, antistatic agents, slip masterbatches, siloxane based slip agents, ultraviolet inhibitors, processing additives, such as oils, resins, including tackifying resins, plasticizers, pigments, additional fillers, fatty acid, zinc oxide, waxes, antioxidants, anti-ozonants, and peptizing agents. Other additives known in the art can also be utilized. Depending on the intended use of the compositions, the additives mentioned above are selected and commonly used in conventional amounts with standard rubber mixing equipment and procedures.

Mixing of one or more of the components can be effected by using conventional mixing equipment such as roll mills, stabilizers, Banbury rotors, Banbury mixers, Brabender mixers, continuous mixers, mixing extruders, etc. at suitable temperatures.

Accelerators can be used to control the temperature and/or time for vulcanization and to improve properties of the vulcanizate. Illustrative, non-limiting, examples of accelerators include thiazole accelerators such as N-tert-butyl-2-benzothiazole sulfenamide (TBBS), dibenzothiazyl disulfide, N-cyclohexyl-2-benzothiazole sulfenamide (CBS), 2-mercaptobenzothiazole, etc.; and/or guanidine accelerators, such as diphenylguanidine (DPG), etc. Combinations of accelerators can be used in any proportions. The amount of accelerator used can be from about 0.1 phr to about 10 phr, such as from about 0.1 phr to about 5 phr, such as from about 0.2 phr to about 4 phr, such as from about 0.5 phr to about 3 phr, such as from about 0.75 phr to about 2.5 phr, such as from about 1 to about 2 phr, such as from about 1 to about 1.5 phr or from about 1.5 phr to about 2 phr. Higher or lower amounts of accelerators are contemplated.

Anti-ozonants, if used, can be present in the compositions in an amount of about 0.1 to about 5 phr, such as from about 0.5 phr to about 3 phr, such as from about 1 to about 2 phr, such as from about 1 to about 1.5 phr or from about 1.5 phr to about 2 phr. Higher or lower amounts of anti-ozonants are contemplated. Antioxidants, if used, can be present in the compositions in an amount of about 0.1 to about 5 phr, such as from about 0.5 phr to about 3 phr, such as from about 1 to about 2 phr, such as from about 1 to about 1.5 phr or from about 1.5 phr to about 2 phr. Higher or lower amounts of antioxidants are contemplated. Examples of anti-ozonants and antioxidants include, but are not limited to, p-phenylenediamine compounds, such as N-(1,3-dimethylbutyl)-N′-phenyl-p-phenylenediamine (6PPD), and 2-mercapto-5-methylbenzimidazole.

Fatty acids that can be used include stearic acid, palmitic acid, linoleic acid, and combinations thereof. The amount of fatty acid can be about 0.1 to about 5 phr, such as from about 0.5 phr to about 3 phr, such as from about 1 to about 2 phr, such as from about 1 to about 1.5 phr or from about 1.5 phr to about 2 phr. Higher or lower amounts of fatty acids are contemplated.

Waxes such as microcrystalline waxes can be used. The amount of wax(es) can be from about 0.1 to about 5 phr, such as from about 0.5 phr to about 3 phr, such as from about 1 to about 2 phr, such as from about 1 to about 1.5 phr or from about 1.5 phr to about 2 phr. In at least one embodiment, the amount of wax(es) can be from about 0.1 phr to about 3 phr or from about 1 phr to about 3 phr. Higher or lower values are contemplated.

Peptizers, such as pentachlorothiophenol, dibenzamidodiphenyl disulfide, and a combination thereof, can be used. The amount of peptizer(s) can be from about 0.1 to about 5 phr, such as from about 0.5 phr to about 3 phr, such as from about 1 to about 2 phr, such as from about 1 to about 1.5 phr or from about 1.5 phr to about 2 phr. In at least one embodiment, the amount of peptizer(s) can from about 0.1 phr to about 1.5 phr. Higher or lower values are contemplated.

In some examples, a method of producing compositions described herein can include one or more of: (1) grinding a coal material; (2) activating the coal material by, e.g., chemical treatment and/or heat treatment (e.g., steam); and/or (3) vulcanizing or dynamically vulcanizing the coal material with a rubber, an elastomer, a thermoplastic, an epoxy, an oil, and/or other components as described above. The mixing may include blending the coal material with the rubber, the elastomer, the thermoplastic, the epoxy, the oil, and/or other components before or after adding curatives.

### EXAMPLES

Two samples of Powder River Basin (PRB) derived carbon powder—coal and char—both milled to match nominal carbon black particle sizes, were investigated as potential filler and/or reinforcement replacements in styrene butadiene rubber as used in the tire industry. The coal char shows reinforcing properties equal to or better than carbon black N990 and N772.

With respect to the coal powder sample, the results indicate that it could be considered as a filler and/or reinforcement replacement of, e.g., calcium carbonate or other fillers and diluent fillers. It is noted that the acidic nature of the coal powder reduces the rate of cure and the level of cross-linking. The low surface area (and likely low structure level) of the coal powder can result in a low level of reinforcement.

The coal char sample disperses well in the styrene butadiene rubber matrix and performs well during the cure mechanism. In some examples, the coal char, in its “raw” (unprocessed) form, offers an improved level of reinforcement to rubber compositions than those obtained from commercial N990 series carbon black. It also appears to have low strain dependency. The coal char can be a replacement for a variety of carbon black grades, e.g., N990 and N772 in a variety of products, for example, tire wall liners, dairy products, sealing rings and gaskets and could also, potentially, be blended with more reinforcing grades of carbon black in some of these uses.

### 1. Example Compositions with Coal Powder

Samples of coal powder, milled to produce fines have been studied variously for colloidal properties, compositional and, primarily, for in-rubber characteristics in terms of reinforcing and enhancement of mechanical properties in styrene butadiene rubber in comparison with standard commercial grades of furnace carbon black.

### Characterization of Coal Powder and Compositions

The following tests were performed on the coal powder samples:

Thermogravimetric analysis (TGA). TGA was performed using a PerkinElmer TGA 4000. Following a 1-minute isothermal hold, an 11 mg sample (which had been dried in a hot air oven for 2 hours at 120° C. prior to analysis) was heated from 40° C. to 600° C. at 20° C./minute in Nitrogen and then cooled back to 400° C. (also at 20° C./minute). After a 5-minute isothermal hold at this temperature, air was introduced, and the remaining sample was heated to 800° C. at 5° C./minute. A final 5-minute isothermal hold was applied at the end temperature.

Energy dispersive X-ray (EDX). EDX analysis was performed using a Bruker Quantax X-ray analyser attached to a Hitachi TM3030 scanning electron microscope (SEM). Approximately 0.1 mg of ash recovered from the thermogravimetric analysis was applied to a carbon sticky tab and the spectrum collected at a 15 keV accelerating voltage, 0° tilt over 600 seconds live time.

Solvent extraction. 2 g of sample was extracted with an equal volume mixture of acetone, dichloromethane, and n-hexane using a Soxhlet apparatus, after which the remaining solid matter was dried for 2 hours at 100° C. in a hot air oven and then allowed to cool under ambient conditions. To quantify the extracted matter, excess solvent was distilled off under vacuum before drying to completion in a hot air oven at 100° C. and allowed to cool before reweighing.

Gas chromatography-mass spectrometry (GC-MS). GC-MS was performed on the dried extract from solvent extraction. The dried extract was re-diluted with 1 ml of chloroform and 3 μl of this solution was injected onto a 30 m BPXS column at 140° C. in a PerkinElmer Clarus 500 gas chromatograph with an attached Clarus 560 mass spectrometer. Following an initial 1-minute isothermal hold, the column temperature was ramped to 330° C. over the 30-minute test duration. Eluted components were detected by mass spectrometry over the range of 33-600 Daltons (Da). A helium carrier was employed at 12.8 psig with a split flow of 40 mL/min applied throughout.

Single pass reflectance infrared spectrometry. The dried chloroform extract was studied using a diamond/zinc selenide single pass reflectance attachment fitted to a PerkinElmer Spectrum One spectrometer. A thin film of the dried extract was spread over the reflectance surface and the spectrum acquired between 4000-600 cm⁻¹ over a minimum of 64 repeat accumulations.

Heating loss. The moisture content was measured according to ASTM D1509.

Toluene discoloration. Testing was performed according to ASTM D1618. The value of toluene discoloration provides an estimate of toluene-soluble discoloring residues present on the filler surface.

Nitrogen surface area (NSA). NSA was used to measure the total and external surface area of fillers based on multipoint nitrogen adsorption. The NSA measurement is based on the B.E.T. theory and it includes the total surface area. The external surface area, based on the statistical thickness method (STSA), is defined as the specific surface area that is accessible to rubber. Testing followed the procedure outlined in ASTM D6556 using a degas temperature of 300° C. Surface area measurements were made on the sample as received and after milling in a ball mill to reduce the particle size.

pH. pH values were determined following Test Method A of ASTM D1512.

Compounding. A generic styrene butadiene rubber (SBR) formulation was used to evaluate the in-rubber performance of the milled filler samples. The ingredients and amounts (in parts per hundred rubber, phr) for the formulation are shown in Table 1. 6PPD is p-phenlenediamine, an anti-ozonant. TBBS is N-tert-butyl-2-benzothiazole sulfenamide (TBBS), an accelerator. TDAE oil is treated distillate aromatic extract (TDAE) oil. Zinc oxide (ZnO), stearic acid were purchased commercially. Various carbon blacks were used as comparative fillers/diluents. Carbon black N990, N772, N660, N550, N326, and N330 were purchased commercially from.

TABLE 1
Generic SBR Formulation

| Ingredient | phr |
|---|---|
| SBR 1502 | 100 |
| rCB or Carbon Black | 60 |
| TDAE Oil | 10 |
| Zinc Oxide | 5 |
| Stearic Acid | 2 |
| 6PPD | 1.5 |
| TBBS | 1.5 |
| Sulfur | 1.5 |

The composition was produced using a HAAKE™ Rheomix OS/610 of 78 cm³ chamber volume with Banbury-style rotors set at 40° C. and 60 rpm, following the procedure outlined in Table 2.

TABLE 2
Mixing Procedure

| | Time (min) | Operation |
|---|---|---|
| Masterbatch Cycle | 1 | Add SBR |
| | 0 | Ram Down |
| | 0.5 | Powders/Oil |
| | 1 | Ram Down |
| | 2 | Ram Bump |
| | 3 | Ram Bump |
| | 5 | Dump |
| Conversion Cycle | / | Add Masterbatch |
| | 0 | Ram Down |
| | 0.33 | Add Curatives |
| | 0.5 | Ram Down |
| | 2 | Dump |

Moving Die Rheometer (MDR). MDR was utilized to assess the cure characteristics of the compounds. Testing was conducted at 160° C. for 60 minutes, following ASTM D5289.

Hardness. Shore A hardness was determined following British Standard International Standard Organization (BS ISO) 48-4, 3 s load time.

Tensile Properties. Were determined following BS ISO 37 using Type 2 dumbbells. Tensile modulus at 100% elongation (M100%), tensile modulus at 300% elongation (M300%), tensile strength (TS), and elongation at break were determined following BS ISO 37 using Type 2 dumbbells.

Dynamic Mechanical Analysis (DMA). Specimens (10 mm×2 mm×2 mm) were cut from the molded sheet, mounted on aluminum blocks using a cyanoacrylate adhesive and tested using a PerkinElmer DMA 8000 analyzer. This was operated in tensile mode and strain sweeps performed at 40° C., 10 Hz frequency over the dynamic strain range 0.05-7.5% dynamic strain aging (DSA) (peak-peak amplitude). A static preload determined by the instrument's ‘auto-tension’ function was applied throughout to prevent the sample entering compression.

### Results for Coal Powder Samples

Filler Characterization. The analytical data generated for the coal powder sample is summarized in Table 3.

TABLE 3
Analytical Results

| | Test | | Result |
|---|---|---|---|
| Surface area, m²/g | | | |
| | NSA | As received | 6.3 |
| | | Milled | 10.7 |
| | STSA | As received | 6.3 |
| | | Milled | 10.7 |
| | pH | | 4.1 |
| | Moisture content, % | | 9.6 |
| | Toluene discoloration, % T | | 79.5 |

| Bulk composition by TGA, wt % | | |
|---|---|---|
| | Volatiles | 7.7 |
| | Organic | 24.7 |
| | Oxidizable | 54.3 |
| | Inorganic | 13.3 |

Colloidal Testing. Two colloidal properties that dictate the reinforcing properties of carbon black and other reinforcing fillers are surface area and structure level, as depicted in Error! Reference source not found. A higher surface area increases the surface available to interact with the rubber matrix, which in-turn, improves reinforcement. A higher structure level leads to increased levels of occluded rubber which further promotes reinforcement. In this study, the surface area of the coal powder was determined; however, some inferences to the structure level can be drawn from the values obtained.

The coal powder sample had an external surface area (STSA) of about 6.3 m²/g as received and about 10.7 m²/g after milling, falling close to the N900 series grades of carbon black (FIG. 2). These results indicate that the coal powder sample has little reinforcing potential. There is no difference between the total surface area (as measured by NSA) and external surface area (STSA), which indicates that the coal powder sample is not porous. However, porosity has little influence on in-rubber reinforcement as the size of the pores makes them inaccessible to the polymer chains of the rubber.

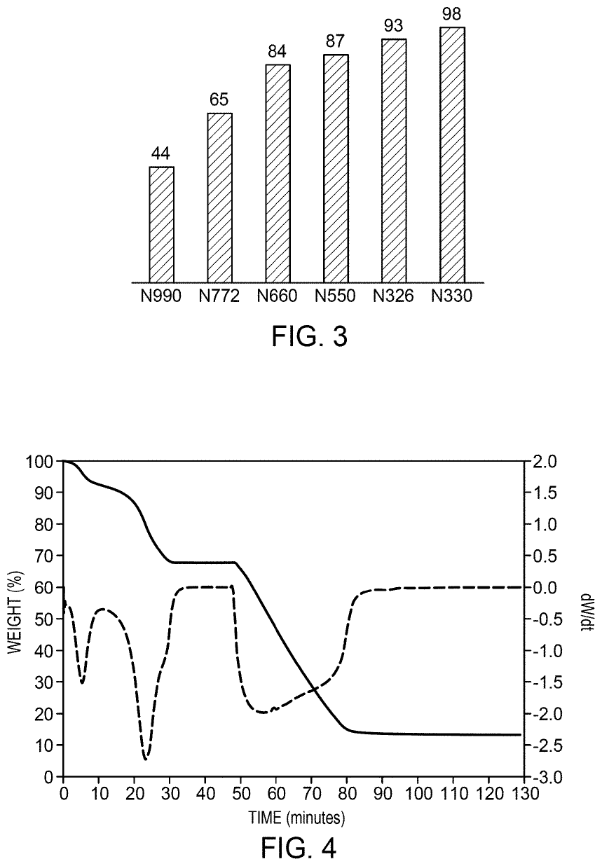

Cleanliness. Toluene discoloration measures the levels of volatile materials remaining on the coal powder sample surface. The coal powder sample had a moderate transmission value of about 79.5%, which is close to N660 grade carbon black. This transmission value indicates the presence of a notable amount of volatile organic matter. Typically, furnace carbon blacks have transmission values between >50% and 100% as shown in FIG. 3. However, the lower surface area grades tend to have lower transmission values due to their limited heat history during production.

Composition. FIG. 4 shows exemplary data for the thermogravimetric weight loss profile, from which the bulk composition of the coal powder sample given in Table 4 was calculated.

TABLE 4
Bulk Composition

| | Time | | Composition, % |
|---|---|---|---|
| Volatiles | To 10.5 minutes (206° C.) | | 7.7% |
| Pryolyzable matter | 10.5-42.7 | minutes | 24.7% |
| Oxidizable matter | 42.7-128.5 | minutes | 54.3% |
| Inorganic residue (ash) | 128.5 | minutes | 13.3% |

The derivative weight loss curve (in blue) in Error! Reference source not found. FIG. 4 exhibits a peak after about 5 minutes at a sample temperature of about 96° C., suggesting the sample is likely to contain residual moisture, despite being dried before analysis. The maximum rate of weight loss associated with the pyrolyzable (organic) matter that is present occurs after about 23 minutes, at a temperature of about 512° C., the relatively high temperature indicating this fraction could be polymeric in nature. Oxidation occurs very rapidly from about 42.7 minutes as compared to conventional grades of carbon black. The speed of oxidation is determined partly by the surface area that is available to react with the oxygen and partly by the microstructure of the carbon, where more regular, graphitic structures tend to be slower oxidizing. However, prior exposure of the carbon to a pro-oxidative environment can result in faster oxidation rates being observed during TGA.

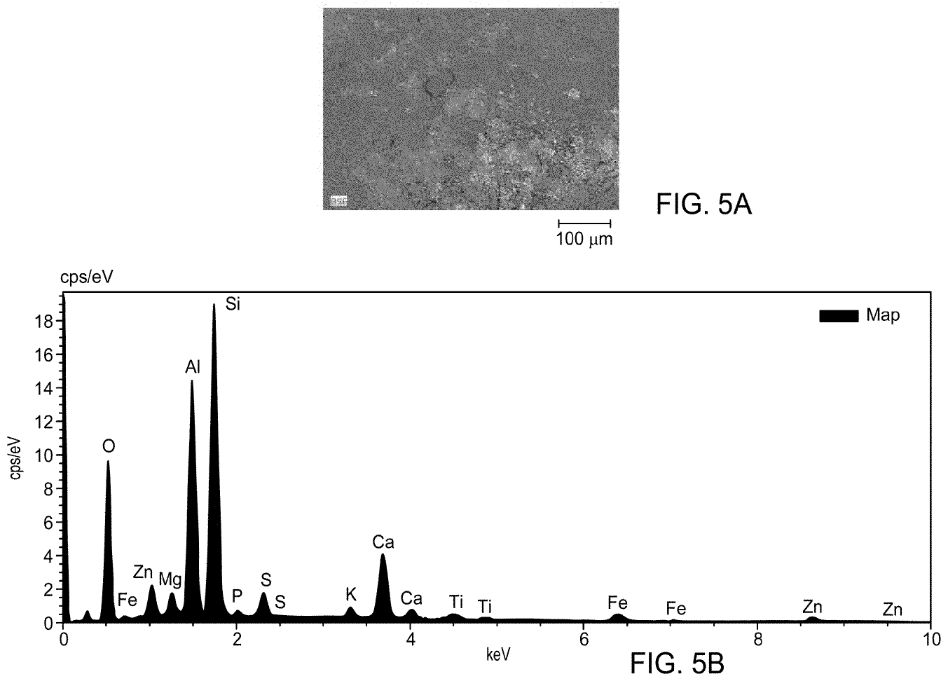

FIG. 5 and Table 5 present the EDX data obtained from the ash remaining after thermogravimetric analysis of the coal powder. The presence of high concentrations of oxygen (O), silicon (Si), and aluminum (Al) indicates that clay is one of the main ash components. A small amount of calcium carbonate (CaCO₃) may also be present, an idea reinforced by the minor weight loss observed at about 90 minutes (630° C.) in the thermogravimetric weight loss profile. The other elements—iron (Fe), sulfur (S), magnesium (Mg), titanium (Ti), potassium (K), and phosphorous (P)—that have been detected are all commonly found in mineral matter except for zinc (Zn); however, it is important to recognize this element experiences interference from sodium and because of this, the zinc content may have been over-estimated.

TABLE 5
Ash Composition

| Element | Atomic Number | Norm. wt % | Norm. atomic % |
|---|---|---|---|
| O | 8 | 38.2 | 55.0 |
| Si | 14 | 23.4 | 19.3 |
| A1 | 13 | 15.4 | 13.2 |
| Ca | 20 | 9.4 | 5.4 |
| Zn | 30 | 4.6 | 1.6 |
| Fe | 26 | 2.9 | 1.2 |
| S | 16 | 2.0 | 1.5 |
| Mg | 12 | 1.5 | 1.4 |
| Ti | 22 | 1.1 | 0.5 |
| K | 19 | 1.1 | 0.6 |
| P | 15 | 0.4 | 0.3 |

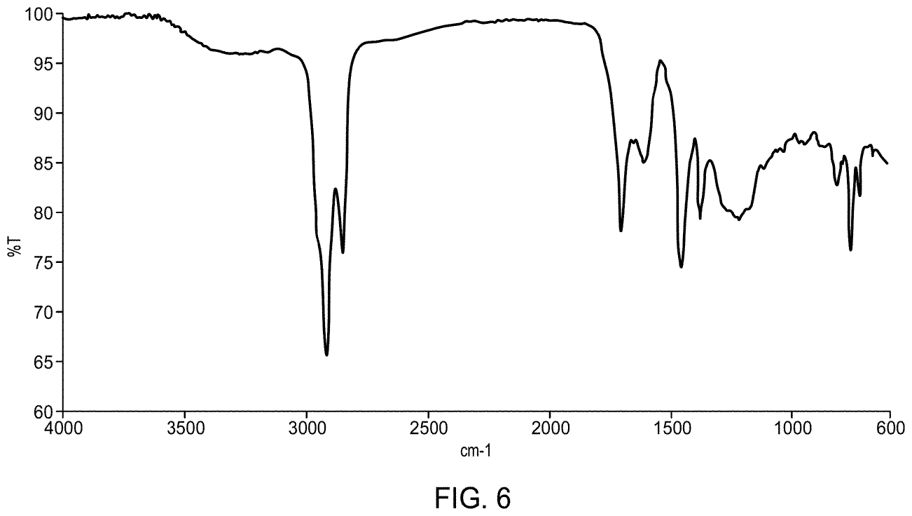

Considering the extracted matter, 1.3% of non-volatile solvent extract was recovered and the infrared spectrum of this is presented in FIG. 6. No good spectral matches were found compared with available library standards, the best (<0.8) being with a variety of heavy aromatic hydrocarbon resins. Further, manual, interpretation of the spectrum suggests that the possible structural units given in Table 6 may be present (subject to interference).

TABLE 6
Manual Assignment of Peaks observed
in the IR Spectrum of FIG. 6

| | X | Y | |
|---|---|---|---|
| Peak | (cm⁻¹) | (% T) | Assignment |
| 1 | 2919.08 | 65.59 | Alkyl groups (CH₂, CH₃) |
| 2 | 2850.12 | 75.92 | Alkyl groups (CH₂, CH₃) |
| 3 | 1704.52 | 78.21 | Alkyl and aromatic aldehydes (CHO) |
| 4 | 1608.68 | 84.88 | Unsaturated compounds (C═C) |
| 5 | 1455.45 | 74.4 | Alkyl groups (CH₂, CH₃), some ethers |
| | | | and esters |
| 6 | 1376.71 | 79.26 | Methyl groups (CH₃), including multiple methyl |
| | | | substitution |
| 7 | 1215.89 | 79.07 | Unassigned |
| 8 | 948.06 | 86.72 | o and m substituted aromatic |
| 9 | 864.1 | 86.45 | Methyl groups |
| 10 | 814.95 | 82.6 | Unassigned, possibly substituted aromatic |
| | | | compound |
| 11 | 755.39 | 76.09 | substituted aromatic compound |
| 12 | 728.97 | 82.32 | Unsaturated compounds (C═C) |
| 13 | 719.39 | 81.48 | Unsaturated compounds (C═C) |
| 14 | 666.89 | 85.63 | Unsaturated compounds (C═C), phenols |

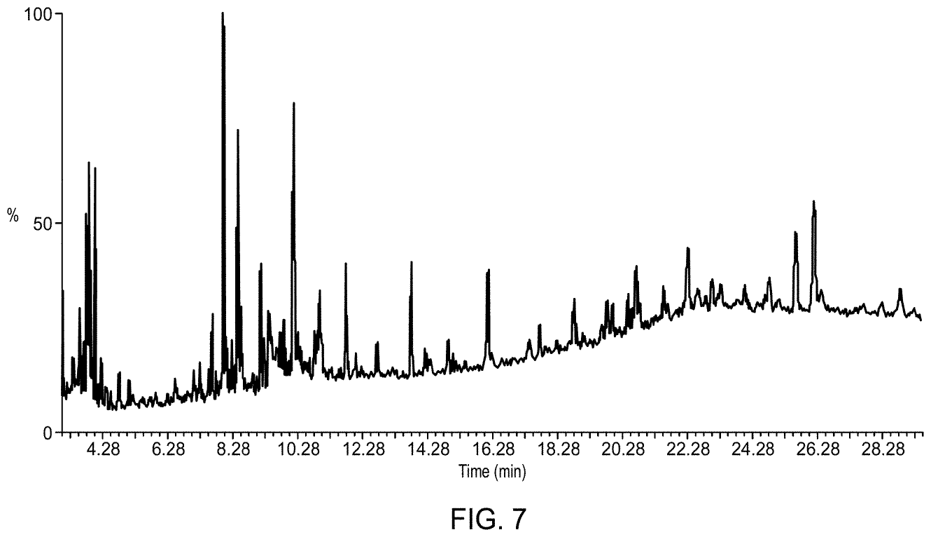

Analysis of the solvent extract by GCMS, shown in FIG. 7, was similarly uninformative. Here, a very large number of compounds were detected, although relatively few were positively identified from their mass spectra, as shown in Table 7. Although no individual component dominates the extract composition, a large number of polynuclear aromatic hydrocarbons are present together with a series of n-alkanes and generally unidentified oxygen-bearing compounds.

A small amount of 2-mercapto-5-methylbenzimidazole was also detected in the extract. 2-mercapto-5-methylbenzimidazole acts as an antioxidant in a variety of material types, including rubbers. Antioxidants may be added to coal dust, such as those produced from low grade coal, to reduce the possibility of spontaneous combustion and are often included as an additive that includes anti-dusting compounds.

TABLE 7
Assigned solvent extract GC-MS peaks observed
in FIG. 7Error! Reference source not found.

| | | Area | | |
|---|---|---|---|---|
| Time | Area | % | Name | CAS # |
| 10.18 | 21272820 | 7.19 | 1-methyl-7-isopropylphenan- | 483-65-8 |
| | | | threne | |
| 8.45 | 14231792 | 4.81 | 7-isopropyl-1,1,4a-trimethyl- | n/a |
| | | | 1,2,3,4,4a,9,10,10a-octahydro- | |
| | | | phenanthrene | |
| 11.78 | 10208422 | 3.45 | pentacosane | 629-99-2 |
| 13.81 | 9371304 | 3.17 | heptacosane | 593-49-7 |
| 16.15 | 8796643 | 2.97 | nonacosane | 630-03-5 |
| 9.43 | 7896590 | 2.67 | 2-mercapto-5-methylbenzimid- | 27231-36-3 |
| | | | azole | |
| 9.86 | 3310176 | 1.12 | Tricosane | 638-67-5 |
| 4.26 | 3252938 | 1.10 | Unresolved mixture, includes 7- | n/a |
| | | | isopropyl-1,4a-dimethyldecahy- | |
| | | | dronaphthalene | |
| 12.76 | 3153855 | 1.07 | hexacosane | 630-01-3 |
| 8.52 | 3062726 | 1.04 | 7-butyl-1-hexylnaphthalene | 55000-55-0 |

### In-Rubber Characterization of the Coal Powder

Various rheology properties of the example SBR formulation having milled coal powder therein (Example 1) was measured. The rheology properties of Example 1 and a series of comparative SBR formulations (C.Ex. 1, C.Ex. 2, C.Ex. 3, C.Ex. 4, and C.Ex. 5) with carbon blacks (CB) are shown in Table 8. Ts2 is the time from the beginning of the test to the time the torque has increased 2 units above its moment lowest value (ML), where the ML value refers to the lowest torque value recorded on the rheometric curve, measured in deci Newton meter (dNm). T90 is the time from the start of the test to the point where 90% of the MH value is reached, where MH (Moment Highest) is the highest torque recorded on the rheometric curve, measured in dNm. Carbon black N772, carbon black N660, carbon black N550, carbon black N326, and carbon black N330 were purchased. The cure properties of the formulations with carbon black are from the United Kingdom's ARTIS archive data.

TABLE 8
Cure Properties

| | Example | Comparative Formulations | | | | |
|---|---|---|---|---|---|---|
| | Formulation | C. | C. | C. | C. | C. |
| | Ex. 1 | Ex. 1 | Ex. 2 | Ex. 3 | Ex. 4 | Ex. 5 |
| Coal powder or | Coal powder | CB | CB | CB | CB | CB |
| carbon black | (FB0001) | N772 | N660 | N550 | N326 | N330 |

Properties

| | | | | | | |
|---|---|---|---|---|---|---|
| Torque | | | | | | |
| Min., dNm | 1.41 | 1.29 | 1.64 | 1.82 | 1.97 | 2.42 |
| Max., dNm | 7.16 | 14.67 | 16.97 | 17.35 | 18.31 | 19.55 |
| Ts2, min. | 15.99 | 5.54 | 5.55 | 5.10 | 3.62 | 4.06 |
| T90, min. | 45.48 | 11.06 | 11.46 | 10.85 | 9.18 | 9.13 |

The powder had significantly longer scorch and cure times than the reference samples (as indicated by Ts2 and T90, respectively), indicating that the cure mechanism has been retarded, as would be expected given the acidic pH of the material. In addition, the maximum torque value is significantly lower than the reference samples indicating that the composition had not reached the same level of cross-linking and that the coal powder is less reinforcing. Based on the MDR data, a cure time of about 60 minutes at about 160° C. was chosen.

The physical properties data of the example and comparative formulations are summarized in Table 9. The physical properties of the formulations with carbon black are from the United Kingdom's ARTIS archive data.

TABLE 9
Physical Properties

| | Example | Comparative Formulations | | | | |
|---|---|---|---|---|---|---|
| | Formulation | C. | C. | C. | C. | C. |
| | Ex. 1 | Ex. 1 | Ex. 2 | Ex. 3 | Ex. 4 | Ex. 5 |
| Coal powder or | Coal powder | CB | CB | CB | CB | CB |
| carbon black | | N772 | N660 | N550 | N326 | N330 |

Properties

| | | | | | | |
|---|---|---|---|---|---|---|
| Shore A hardness, ° | 46 | 56 | 62 | 63 | 60 | 67 |
| M100%, MPa | 0.97 | 1.69 | 2.63 | 2.83 | 1.75 | 1.61 |
| M300%, MPa | 1.90 | 7.51 | 12.7 | 13.3 | 8.15 | 17.0 |
| Tensile strength, MPa | 4.71 | 20.3 | 20.3 | 20.2 | 24.6 | 25.9 |
| Elongation at break, % | 1270 | 580 | 492 | 491 | 607 | 453 |

The data in Table 9 show that stiffness (hardness, M100% and M300%) and tensile strength were all lower than the comparative samples, and that elongation at break was higher. This can largely be the result of reduced polymer-filler interactions with the coal powder; however, interaction with the cure package, as identified with the MDR data, can also be a contributor.

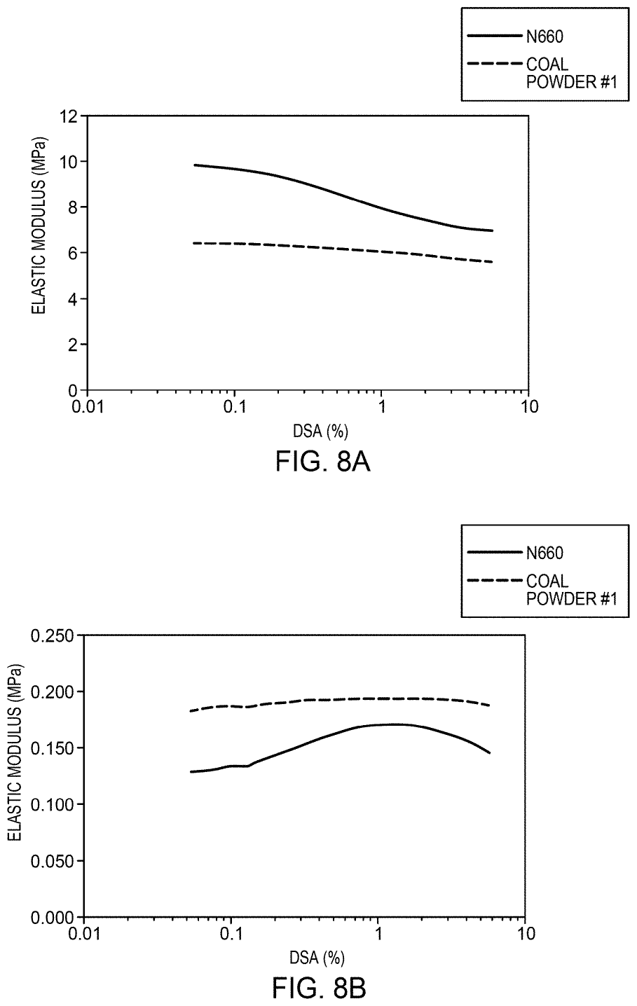

When mixed in a rubber matrix, carbon black aggregates have a tendency to associate with each other to form agglomerates, owing to van der Waals type attraction forces between particles. Under dynamic loading, the elastic modulus (E′) decreases with increasing strain amplitude from a high plateau E′₀ to a low plateau E′_{∞}. This phenomenon is known as the Payne effect and provides a measure of the level of filler-filler interactions. The DMA strain sweep plots for the coal powder sample are shown in FIGS. 8A and 8B, where data obtained from the same formulation but containing N660 Carbon black is also included, demonstrating the low reinforcement obtained with the coal powder and the high hysteresis (a higher tan delta (tan δ) maximum).

The coal powder could be considered as a diluent filler, acting as a potential replacement for, e.g., calcium carbonate, used to reduce the cost of certain compounds.

### 2. Example Compositions with Coal Char

Samples of char, milled to produce fines have been studied variously for colloidal properties, compositional and, primarily, for in-rubber characteristics in terms of reinforcing and enhancement of mechanical properties in styrene butadiene rubber (SBR) in comparison with standard commercial grades of furnace carbon black. Physical characterization data for both coal and char have previously been given in Report No 2 (August 2020).

### Characterization of Coal Char and Compositions

The following tests were performed on the char samples:

Compounding. A generic SBR formulation was used to evaluate the in-rubber performance of the milled filler sample, as detailed in Table 10. SBR, carbon black, TDAE oil, ZnO, stearic acid, 6PPD, TBBS, and sulfur are described above.

TABLE 10
Generic SBR Formulation

| | parts per hundred |
|---|---|
| Ingredient | rubber (phr) |
| SBR 1502 | 100 |
| rCB or Carbon Black | 60 |
| TDAE Oil | 10 |
| Zinc Oxide | 5 |
| Stearic Acid | 2 |
| 6PPD | 1.5 |
| TBBS | 1.5 |
| Sulfur | 1.5 |

The composition was produced using a HAAKE™ Rheomix OS/610 of 78 cm³ chamber volume with Banbury-style rotors set at 40° C. and 60 rpm, following the procedure outlined in Table 11.

TABLE 11
Mixing Procedure

| | Time (min) | Operation |
|---|---|---|
| Masterbatch Cycle | / | Add SBR |
| | 0 | Ram Down |
| | 0.5 | Powders/Oil |
| | 1 | Ram Down |
| | 2 | Ram Bump |
| | 3 | Ram Bump |
| | 5 | Dump |
| Conversion Cycle | / | Add masterbatch |
| | 0 | Ram Down |
| | 0.33 | Add Curatives |
| | 0.5 | Ram Down |
| | 2 | Dump |

Moving Die Rheometer (MDR). MDR was utilized to assess the cure characteristics of the compounds and to allow preparation of cured sheets using a cure time of T90+5 minutes. Testing was conducted at 160° C. for 30 minutes, following ASTM D5289.

Dispersion Assessment. Sections of the composition were prepared using fresh razor blades and imaged using optical microscopy at ×5 magnification under dark field lighting. Surface roughness maps (×250 magnification) were also generated using a Hitachi TM3030 SEM fitted with an annular multi-segmented back-scattered electron detector.

Density. Density was determined following BS ISO 2781+A1.

Hardness, tensile properties, and dynamic mechanical analysis (DMA) were determined as described above.

### In-Rubber Characterization of the Coal Char

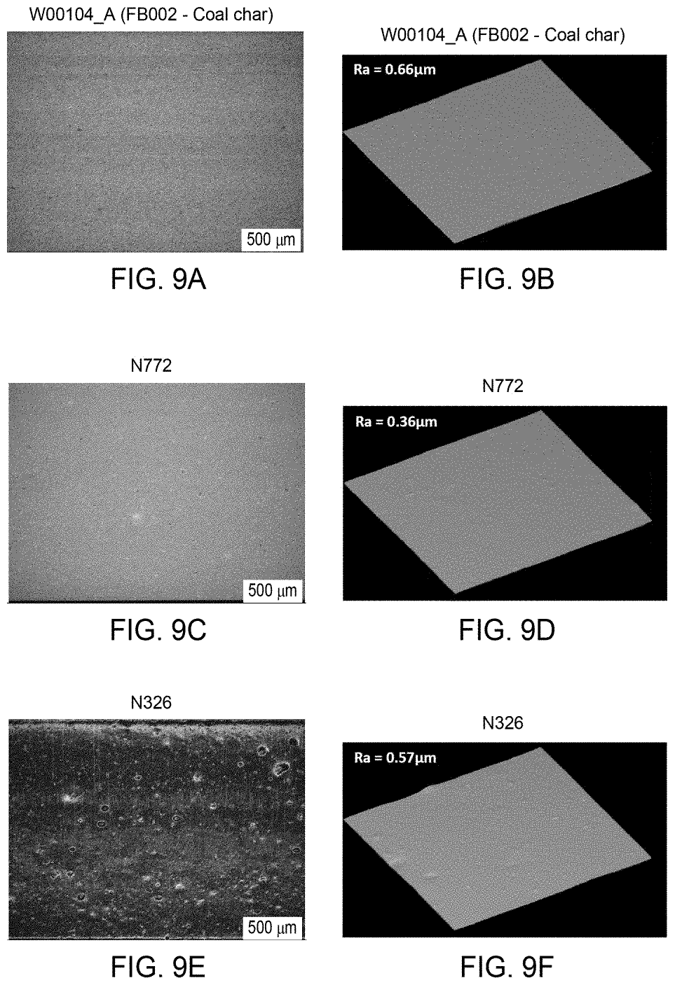

Following compounding into the SBR formulation, the dispersion level achieved with the coal char sample was assessed. The optical images and SEM 3D surface roughness maps provided in FIG. 9 reveal that the coal char was highly dispersible, achieving a dispersion level similar to that of the N326 reference carbon black. The char did not quite match the dispersion level of lower surface area carbon blacks, such as N772, possibly due to a difference in particle size distribution.

Various rheology properties of the example SBR formulation having milled coal char therein (Example 2) was measured. The rheology properties of Example 2 and a series of comparative SBR formulations (C.Ex. 6, C.Ex. 7, C.Ex. 8, C.Ex. 9, and C.Ex. 10) with carbon blacks are shown in Table 12. Ex. 2 and C.Ex. 6-10 were made according to Tables 10 and 11.

TABLE 12
Cure Properties

| | Example | Comparative Formulations | | | | |
|---|---|---|---|---|---|---|
| | Formulation | C. | C. | C. | C. | C. |
| | Ex. 2 | Ex. 6 | Ex. 7 | Ex. 8 | Ex. 9 | Ex. 10 |
| Coal char or | Coal char | CB | CB | CB | CB | CB |
| carbon black | | N990 | N772 | N660 | N550 | N330 |

Properties

| | | | | | | |
|---|---|---|---|---|---|---|
| Torque | | | | | | |
| Min., dNm | 1.42 | 0.95 | 1.29 | 1.54 | 1.82 | 2.10 |
| Max., dNm | 11.11 | 12.58 | 14.69 | 16.29 | 16.78 | 18.49 |
| Ts2, min. | 5.65 | 8.89 | 5.63 | 5.71 | 5.16 | 4.54 |
| T90, min. | 15.62 | 15.85 | 11.23 | 11.74 | 11.66 | 9.96 |

The coal char sample did not result in under-cure of the compound, as was found with the coal powder sample and the scorch (as indicated by Ts2) and cure (indicated by T90) times similar to those recorded for N990 and N772 grade carbon blacks. The minimum torque value provides a measure of composition viscosity, suggesting the coal char falls between the N700 and N600 series carbon blacks for this parameter. The reinforcing properties of the filler and final composition cross-link density contribute to the measured MDR maximum torque value. This data point indicates that the coal char gives low reinforcement of the compound.

The physical properties data of the example and comparative formulations are summarized in Table 13. The data indicates that the example formulation has stiffness values being slightly higher than N990. The tensile strength is lower than that recorded for N990, which may be related to particle size.

TABLE 13
Physical Properties

| | Example | Comparative Formulations | | | | |
|---|---|---|---|---|---|---|
| | Formulation | C. | C. | C. | C. | C. |
| | Ex. 2 | Ex. 6 | Ex. 7 | Ex. 8 | Ex. 9 | Ex. 10 |
| Coal char or | Coal char | CB | CB | CB | CB | CB |
| carbon black | | N990 | N772 | N660 | N550 | N330 |

Properties

| | | | | | | |
|---|---|---|---|---|---|---|
| Shore A hardness, ° | 50 | 50 | 56 | 60 | 64 | 66 |
| M100%, MPa | 1.34 | 1.22 | 1.84 | 2.31 | 3.21 | 2.85 |
| M300%, MPa | 4.56 | 3.71 | 7.79 | 10.50 | 13.7 | 14.2 |
| Tensile strength, MPa | 10.2 | 17.2 | 19.0 | 19.3 | 20.0 | 24.1 |
| elongation at break, % | 775 | 797 | 658 | 569 | 483 | 466 |

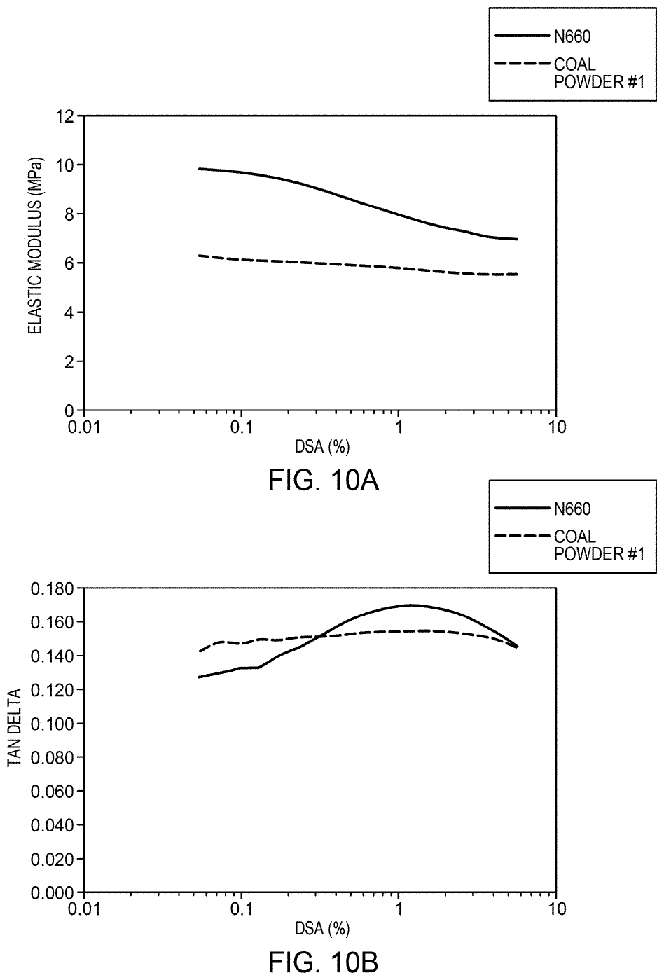

When mixed in the rubber matrix, carbon black aggregates have a tendency to associate with each other to form agglomerates, owing to van der Waals type attraction forces between particles. Under dynamic loading, elastic modulus (E′) decreases with increasing strain amplitude from a high plateau E′₀ to a low plateau E′_{∞}, this phenomenon is known as the Payne effect and provides a measure of the level of filler-filler interactions (i.e. the filler network). The DMA strain sweep plots for the coal char sample are shown in FIGS. 10A and 10B, where data obtained from the same formulation but containing N660 Carbon black is also included, demonstrating the lower reinforcement provided by the coal char sample. However, the plots also indicate that the coal char sample has a lower strain dependency and this characteristic could be very beneficial in tire sidewall and liner applications if the filler can be blended with carcass grades of carbon black. FIG. 10B shows tan delta values.

The coal char sample disperses well in the SBR matrix and did not have the deleterious effect on the rubber cure mechanism seen with the coal powder sample. It offers a low level of reinforcement to rubber compounds that is slightly better than that obtained from N990 series carbon black. It also appears to have low strain dependency. Therefore, it has potential as a replacement for N990 and could also, potentially, be blended with more reinforcing grades of carbon black in tire sidewall and liner compounds.

### 3. Example Use in Supercapacitors

Table 1 shows properties of an example coal powder sample and an example char sample utilized as electrodes in a supercapacitor test device. The coal powder sample had a near-zero porosity. The coal powder and char samples were activated using potassium hydroxide (KOH) to adjust the performance and capacitance of the samples. As shown in Table 14, the capacitance of each sample could be increased by about 62% for the coal powder and by about 44% for the char sample. These results indicate that coal-derived materials can be utilized in supercapacitors. For example, those from the coal powders since firstly it appears possible to make a supercapacitor device simply from coal and, additionally, as KOH activation is a relatively simple and cheap processing method for both carbon samples.

TABLE 14

| Sample | Coal Powder | Char |
|---|---|---|
| BET surface area (m²/g) | 2.6 | 376 |
| Total pore volume (cm³/g) | — | 0.18 |
| Average pore width (nm) | — | 3.1 |
| Micropore volume (cm³/g) | — | 0.12 |
| Surface area within micropores (m²/g) | — | 291 |
| External area (m²/g) | — | 84 |
| Capacitance before activation with KOH (F/g) | 131.8 | 118.8 |
| Capacitance after activation with KOH (F/g) | 213.5 | 170.6 |

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, e.g., the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise.

While the foregoing is directed to aspects of the present disclosure, other and further embodiments of the disclosure may be devised without departing from the basic scope thereof, and the scope thereof is determined by the claims that follow.

What is claimed is:

1. A composition, comprising:
a coal-derived component comprising coal powder, coal char produced by thermal treatment such as pyrolysis, or solvent extraction to produce an extract or residual carbon or a combination thereof; and
an elastomer component.

2. The composition of claim 1, wherein the composition comprises:
from about 20 wt % to about 60 wt % of the coal-derived component based on a total weight of the composition,
from about 40 wt % to about 80 wt % of the rubber component based on the total weight of the composition, wherein the total weight percent of the composition does not exceed 100 wt %.

3. The composition of claim 1, wherein the coal-derived component has a BET surface area from about 200 m²/g to about 550 m²/g as determined by NSA.

4. The composition of claim 1, wherein the elastomer component is at least partially cross-linked.

5. The composition of claim 1, wherein the elastomer component is not crosslinked.

6. The composition of claim 1, further comprising:
an oil;
a fatty acid, an antioxidant, an anti-ozonant, or combinations thereof; or
a combination thereof.

7. The composition of claim 1, wherein the composition has:
a Shore A hardness (BS ISO 48-4, 3 s load time) of about 30 to about 70;
a tensile modulus at 100% elongation (BS ISO 37) of about 1 to about 5 MPa;
a tensile modulus at 300% elongation (BS ISO 37) of about 3 MPa to about 15 MPa;
a tensile strength (BS ISO 37) of about 9 MPA to about 25 MPa;
an elongation at break (BS ISO 37) of about 400 MPa to about 1000 MPa; or
combinations thereof.

8. The composition of claim 1, wherein the elastomer component comprises a styrene-based rubber, a nitrile rubber, a butyl rubber, or combinations thereof.

9. A composition comprising:
a coal-derived component comprising coal powder, coal char, or a combination thereof; and
a thermoplastic component, wherein the composition comprises:
from about 20 wt % to about 60 wt % of the coal-derived component based on a total weight of the composition,
from about 40 wt % to about 80 wt % of the thermoplastic component based on the total weight of the composition, and
wherein the total weight percent of the composition does not exceed 100 wt %.

10. The composition of claim 9, wherein the composition further comprises an elastomer component in an amount of about 10 wt % to about 30 wt % based on the total weight of the composition.

11. The composition of claim 9, wherein the thermoplastic component comprises a polyethylene or a polypropylene.

12. The composition of claim 9, wherein the thermoplastic component comprises a low-density polyethylene.

13. The composition of claim 9, wherein the coal-derived component is coal char.

14. The composition of claim 9, wherein the coal-derived component has a BET surface area from about 200 m²/g to about 550 m²/g as determined by NSA.

15. A method of producing a composition, comprising vulcanizing a mixture comprising a coal-derived component, an elastomer component, and a curative to produce the composition.

16. The method of claim 15, further comprising extruding the composition.

17. The method of claim 15, wherein the elastomer component comprises a styrene-based rubber, a nitrile rubber, a butyl rubber, or combinations thereof.

18. The method of claim 15, wherein the curative comprises a metal oxide, a sulfur agent, or a combination thereof.

19. The method of claim 15, wherein the coal-derived component is coal char, coal powder, or a combination thereof.

20. The method of claim 15, wherein the mixture further comprises a plasticizer or an oil.
